(19) United States
(12) Patent Application Publication
(10) Pub. No.: US 2026/0365856 A1
(43) Pub. Date: Nov. 19, 2026

(54) PLASMA PROCESS FOR PRODUCING CARBON BLACK

(71) Applicant: Cabot Corporation, Boston, MA (US)

(72) Inventors: David M. Matheu, Arlington, MA (US); Frederick H. Rumpf, Billerica, MA (US); Gregory T. Gaudet, St. Charles, IL (US)

(21) Appl. No.: 19/671,920

(22) Filed: May 8, 2026

Related U.S. Application Data
(60) Provisional application No. 63/805,436, filed on May 14, 2025.
(60) Provisional application No. 63/911,906, filed on Nov. 5, 2025.
(60) Provisional application No. 63/938,783, filed on Dec. 11, 2025.

(51) Int. Cl. C09C 1/48; B01J 19/08

(52) U.S. Cl. CPC C09C 1/48; B01J 19/088; B01J 2219/0807; B01J 2219/0843; B01J 2219/0898

(57) ABSTRACT

A method of making carbon black includes generating a plasma in a gas stream to create a hot carrier gas stream and combining a feedstock comprising a liquid feedstock with the hot carrier gas stream to generate a carbon black. The mixture of the feedstock and the hot carrier gas has an atomic ratio H:C of at most 3:1. Either a net energy to manufacture 1 kg of carbon black is no greater than 6 kWh, a gas traffic in the reactor is no greater than 1 kmol/kg carbon black, or both.

This application claims priority from U.S. Provisional Applications Nos. 63/805,436 filed May 14, 2025, 63/911,906, filed Nov. 5, 2025, and 63/938,783 filed Dec. 11, 2025, the contents of all of which are incorporated herein by reference.

### BACKGROUND

### 1. Field

Disclosed and provided herein are methods for producing carbon black in a carrier gas heated using a plasma.

### 2. Description of the Related Art

Carbon black is typically produced by pyrolyzing a carbon-containing feedstock, followed by polymerization of the pyrolyzed species to form carbon black precursors that condense into seed particles which in turn condense into larger particles. The pyrolysis requires high temperatures. In furnace black processes, the high temperature is provided by combusting a fuel such as natural gas. Complete combustion of the natural gas to create a hot carrier gas results in the generation of carbon dioxide, which is typically not available to form carbon black. It is desirable to form carbon black with reduced generation of carbon dioxide.

Plasma reactors for production of carbon black use electrical or electromagnetic energy to heat a gas to provide the high temperature for pyrolysis. It is desirable to develop plasma processes and apparatus that are able to more efficiently generate high surface area carbon blacks with low levels of uncondensed species (e.g., low amounts of toluene extractables). It is further desirable to reduce fouling of the reactor. A typical method of fouling is by deposition of coke on the walls of the plasma carbon black reactor, which retards the flow of gases and newly manufactured carbon black through the reactor.

### SUMMARY

In one embodiment, a method of making carbon black includes generating a plasma in a gas stream to create a hot carrier gas stream and combining a feedstock comprising a liquid feedstock with the hot carrier gas stream to generate or produce a carbon black. The mixture of the feedstock and the hot carrier gas has an atomic ratio H:C of at most 3:1. Either a net energy to manufacture 1 kg of carbon black is no greater than 6 kWh, a gas traffic in the plasma carbon black reactor is no greater than 1 kmol/kg carbon black, or both.

In another embodiment, a method of making carbon black comprises generating a plasma in a gas stream to create a hot carrier gas stream and combining a feedstock with the hot carrier gas stream. The mixture of the feedstock and the hot carrier gas has an atomic ratio O:C of from 0.05 to 2 and an atomic ratio H:C of at most 3:1, to produce carbon black.

In another embodiment, a method of making carbon black comprises generating a plasma in a gas stream to create a hot carrier gas stream, introducing the hot carrier gas stream to a circularly cross-sectioned region of a plasma carbon black reactor, the hot carrier gas stream being introduced along a longitudinal axis of the circularly cross-sectioned region, and combining a feedstock comprising a liquid feedstock with the hot carrier gas stream to form carbon black. The mixture of the feedstock and the hot carrier gas has an atomic ratio H:C of at most 3:1. A net energy input Q is no greater than 6 kWh/kg carbon black for I2No being less than 100 mg/g and satisfies the equation I2No≥7Q+58 for I2No of 100 mg/g or greater, where I2No is in mg/g and Q is in kWh/kg carbon black, and a gas traffic during the reaction is no greater than 1 kmol/kg carbon black.

In another embodiment, a method of making carbon black comprises generating a plasma in a gas stream to create a hot carrier gas stream, introducing the hot carrier gas stream to a reaction zone of a carbon black reactor, the reaction zone having a substantially cylindrical wall, the hot carrier gas stream being introduced at an angle to the wall that is within 10 degrees of a tangent to the wall, for example, within 5 degrees, within 2 degrees, or within 1 degree of a tangent to the wall, and combining a feedstock with the hot carrier gas stream to form carbon black. The feedstock may be a liquid feedstock.

In another embodiment, a method of making carbon black comprises generating a plasma in a gas stream to create a hot carrier gas stream, introducing the hot carrier gas stream to a circularly cross-sectioned region of a plasma carbon black reactor, the hot carrier gas stream being introduced along a longitudinal axis of the circularly cross-sectioned region, and combining a feedstock comprising a liquid feedstock with the hot carrier gas stream to form carbon black. The mixture of the feedstock and the hot carrier gas has an atomic ratio H:C of at most 3:1. A surface area of the carbon black satisfies I2No≥188 (gas traffic)−8, where iodine number is in mg/g and gas traffic is in kmol/kg carbon black, and a gas traffic is no greater than 1 kmol/kg carbon black.

In another embodiment, a method for producing carbon black includes generating a first plasma in a first gas stream in a first plasma zone of a plasma carbon black reactor to create a first hot carrier gas stream, generating a second plasma in a second plasma zone of the plasma carbon black reactor to create a second hot carrier gas stream, directing the first and second hot carrier gas streams towards each other along first and second axes such that the first and second hot carrier gas streams combine at a location in a reaction zone having a third axis, wherein the first and second axes are at an angle from 30 to 90 deg to an upstream end of the reaction zone, and directing a feedstock towards the location, to one more cross-sections of the reaction zone downstream of the location, or both, to mix the feedstock with the combined first and second hot carrier gas streams to produce carbon black, the carbon black leaving the reaction zone at a downstream end. For example, the angle may be from 40 to 90 deg, from 50 to 90 deg, from 70 to 90 deg, from 80 to 90 deg, or 90 deg (i.e., perpendicular) with respect to an upstream end of the reaction zone.

In another embodiment, an apparatus for producing carbon black comprises first and second plasma zones and a reaction zone, the reaction zone having an upstream end and a downstream end, a first plasma transport zone providing fluidic communication between the first plasma zone and the reaction zone and having an outlet, a second plasma transport zone providing fluidic communication between the second plasma zone and the reaction zone and having an outlet, the first and second plasma transport zones each being configured to direct a fluid along first and second axes, respectively, the first and second axes being at an angle of 30-90 deg with respect to the upstream end, the outlets being disposed on a common axis at a perpendicular angle to the reaction zone, and a plurality of feedstock injectors configured to direct a fluid towards a predetermined location in the reaction zone that is between the two outlets or downstream from the two outlets. For example, the angle may be from 40 to 90 deg, from 50 to 90 deg, from 70 to 90 deg, from 80 to 90 deg, or 90 deg (i.e., perpendicular) with respect to an upstream end of the reaction zone.

In another embodiment, an apparatus for heating a gas with the use of a plasma comprises a tubular inner chamber defined by an inner wall and having an inlet end and an outlet end, an outer chamber in the form of at least one cylindrical shell between an outer wall and the inner wall, the outer chamber being in fluidic communication with the inner chamber at the inner chamber inlet end, an electrode disposed at the inner chamber inlet end and oriented along a central axis of the inner chamber, and an electrode disposed at the outlet end.

In another embodiment, a transferred arc plasma apparatus for producing carbon black comprises a plasma zone having an inlet to receive a gas and an outlet in fluidic communication with a reaction zone, an electrode disposed in the plasma zone, and an anode bed disposed in the plasma zone and opposed to the electrode, an axis defined by the electrode and the anode bed being perpendicular to a direction of gas flow through the plasma zone, the anode bed comprising one or more of silicon, iron, aluminosilicates, magnesium oxide, yttria stabilized zirconia, or molten salts.

It is to be understood that both the foregoing general description and the following detailed description are exemplary and explanatory only and are intended to provide further explanation of the present embodiments, as claimed.

### BRIEF DESCRIPTION OF THE DRAWING

FIG. 1 is a schematic diagram of an exemplary plasma carbon black reactor.

FIG. 2 is a schematic diagram of the use of a heat exchanger with the plasma carbon black reactor of FIG. 1.

FIG. 3 is a schematic diagram of an exemplary plasma carbon black reactor.

FIG. 4 is a schematic diagram of an exemplary plasma zone of a plasma carbon black reactor.

FIG. 5A is a schematic diagram of a plasma zone of an exemplary plasma carbon black reactor.

FIG. 5B is a view of a portion of an alternative embodiment of the plasma carbon black reactor of FIG. 5A.

FIG. 6A is a schematic diagram of an exemplary plasma carbon black reactor.

FIG. 6B is a schematic diagram of an exemplary plasma carbon black reactor.

FIG. 6C is a schematic diagram of an exemplary plasma carbon black reactor.

FIG. 6D is a schematic diagram of an exemplary plasma carbon black reactor.

FIG. 6E is a schematic diagram of an exemplary feedstock nozzle for use with a plasma carbon black reactor according to the embodiments provided herein.

FIG. 7A is a schematic diagram of a perspective view of a portion of a plasma carbon black reactor.

FIG. 7B is schematic diagram of an alternative configuration of the portion of the plasma carbon black reactor depicted in FIG. 7A

FIG. 7C is a schematic diagram of the plasma carbon black reactor depicted in perspective in FIG. 7A.

FIG. 7D is a schematic diagram of an alternate configuration of a plasma zone in an exemplary plasma carbon black reactor.

FIG. 8 is a schematic diagram of a portion of an exemplary plasma carbon black reactor.

FIG. 9 is a schematic diagram of an exemplary plasma carbon black reactor.

FIGS. 9A and 9B are schematic diagrams of exemplary plasma carbon black reactors.

FIGS. 10 and 10A are schematic diagrams of a portion of an exemplary plasma carbon black reactor.

FIG. 11 is a schematic diagram of a cross-sectional view of a reaction, or reactor, zone

FIG. 12 is a schematic diagram of a system for treating combusted tail gas from a plasma carbon black reactor according to various embodiments.

FIGS. 13A, 13B, 13C, 14A and 14B are schematic diagrams of various exemplary plasma carbon black reactors.

FIGS. 15 and 16 are graphs of carbon black iodine number (g/100 g) versus gas traffic (FIG. 15, kmol/kg C) and net energy input (FIG. 16, kWh/kg C) for various carbon blacks produced using various operating conditions (circle—axial introduction of plasma, nitrogen carrier gas, gas traffic no greater than 1 kmol/kg C; triangle—nitrogen carrier gas, gas traffic greater than 1 kmol/kg C; diamonds—tangential introduction of plasma, nitrogen carrier gas, gas traffic no greater than 1 kmol/kgC; square—axial introduction of plasma, hydrogen carrier gas; x—tangential introduction of plasma, hydrogen carrier gas).

### DETAILED DESCRIPTION

In one embodiment, a method of making carbon black includes generating a plasma in a gas stream to create a hot carrier gas stream and combining a feedstock comprising a liquid feedstock with the hot carrier gas stream to generate or produce a carbon black. The mixture of the feedstock and the hot carrier gas has an atomic ratio H:C of at most 3:1. Either a net energy to manufacture 1 kg of carbon black is no greater than 6 kWh, a gas traffic in the reactor is no greater than 1 kmol/kg carbon black, or both.

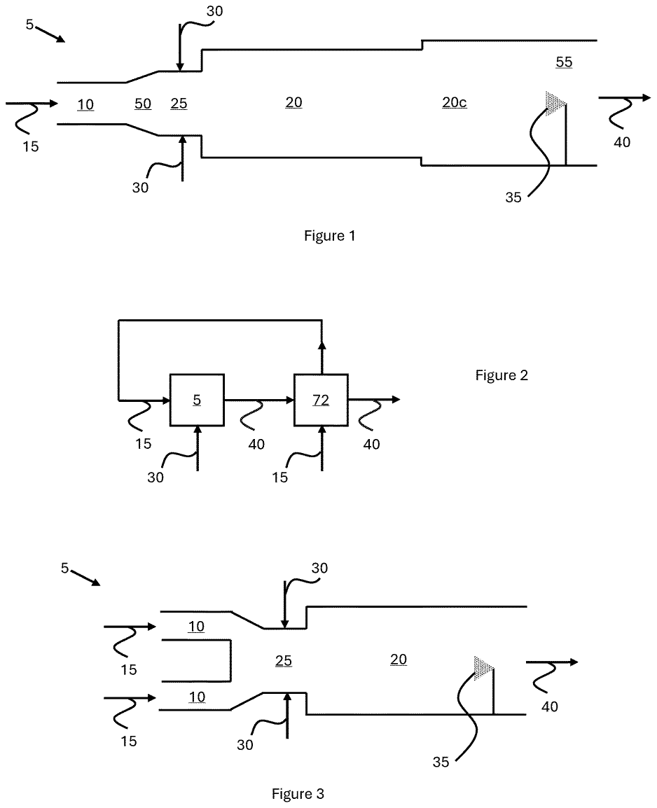

The plasma may be generated in a plasma zone 10 of plasma carbon black reactor 5 (FIG. 1). A carrier gas 15 is injected into plasma zone 10, and a plasma is generated by applying energy in the form of an electric, magnetic, and/or electromagnetic field through carrier gas 15 as described further below. The electromagnetic energy causes the carrier gas 15 to become very hot and ionized. The hot carrier gas proceeds through the plasma carbon black reactor, for example, through throat 25, into a reaction zone, e.g., reactor zone 20. The terms reactor zone and reaction zone are used interchangeably throughout. As the hot carrier gas proceeds, the ionized species recombine with electrons such that the hot carrier gas in reactor zone 20 may or may not still be considered a plasma or partial plasma. In throat 25, a hydrocarbon feedstock 30 is injected into the hot carrier gas stream. As a result of the high temperature of the hot carrier gas, the hydrocarbon feedstock 30 pyrolyzes and is converted to carbon black. The carbon black-forming reactions are quenched using quench spray 35, following which the resulting smoke stream 40 of carbon black and gases exits plasma carbon black reactor 5. The gases in smoke stream 40 include unreacted species from hot carrier gas 15 along with gases generated during the reaction of the feedstock to form carbon black.

The mixture of the feedstock and the hot carrier gas has an atomic ratio H:C of at most 3:1, for example, at most 2.5:1, at most 2:1, at most 1.5:1, at most 1.3:1, at most 1:1, at most 1.5:2, at most 1.3:2, from 1:2 to 3:1, from 1.5:2 to 2.5:1, or from 1.3:2 to 2:1. To achieve this, the carrier gas preferably has small amounts of hydrogen gas, for example, at most 5 vol % hydrogen. The carrier gas may comprise nitrogen, argon, carbon dioxide, water vapor, carbon monoxide, or a blend of two or more of these. Small amounts of oxygen or other gases may also be present provided the O:C ratio of the mixture of the feedstock and the hot carrier gas remains within the ranges specified elsewhere herein. The carrier gas may be produced by gas separation from atmospheric air using commercially available methods, purchased from a vendor, produced from the tail gas as described below, or some combination of these. We have found that the use of higher H:C ratios increases one or both of the gas traffic or the net energy required to manufacture the carbon black. We have also found that high amounts of hydrogen suppress pyrolysis of the carbon black-forming feedstock, inhibiting development of carbon black, especially higher surface area carbon black, and promotes coke deposition.

The carbon black feedstock comprises a liquid hydrocarbon feedstock. Preferable feedstocks include traditional feedstocks for furnace methods of producing carbon black, for example, decant and slurry oils, coker oils, coal tars and coal tar distillate fractions, and ethylene or phenol cracker residues. Such feedstocks typically have H:C ratios of at most 1.23. Furthermore, such feedstocks typically have a Bureau of Mines Correlation Index (BMCI)≥100 and a specific gravity >1.02. In addition, liquid feedstocks derived from biological or recycled sources may also be employed. Such feedstocks typically have higher H:C ratios and/or lower densities and/or lower BMCI than “traditional” feedstocks and include but are not limited to a tire pyrolysis oil, a plastic pyrolysis oil, a recycled oil, an algal oil, a plant-derived oil, an oil derived from pyrolysis of municipal solid waste, an oil derived from the pyrolysis or decay of biomass (e.g., animal or vegetable) or agricultural waste, an oil derived from the processing of pulp or paper production byproducts vegetable or other plant-derived oil, a bio-sourced ethanol, a plant- or animal-produced wax or resin, an oil rendered from animal fat, an algal oil, an oil rendered from the pyrolysis of sewage sludge or agricultural waste, a byproduct liquid from processing of a biogenic material, a liquid produced by hydrothermal liquefaction of a biomaterial, rubber, or plastic, a crude tall oil, a tall oil rosin, a tall oil pitch, or a tall oil fatty acid, an oil produced from recycled material, an oil derived from the pyrolysis of off-quality, rejected, or end-of-life tires, an oil derived from the pyrolysis of discarded or recycled plastics or rubber products, an oil derived from the pyrolysis of municipal solid waste, or an oil derived from the pyrolysis of biomass. Gaseous hydrocarbons, e.g., natural gas, methane, ethylene, propane, or mixtures of two or more of these, may be included in the carbon black feedstock as well, provided the overall H:C ratio in the mixture of the hot carrier gas and the feedstock falls within any of the ranges provided above. We have found that the use of liquid feedstocks can reduce coke deposition. In preferred embodiments, the feedstock has a flashpoint of at least 40 degC.

In certain embodiments, the feedstock may also have particulate matter dispersed within it. Such particulate matter may be present in an amount of up to 50% by mass, for example, from 1 wt % to 5 wt %, from 5 wt % to 15 wt %, from 15 wt % to 25 wt %, from 25 wt % to 35 wt %, from 35 wt % to 45 wt %, or from 40 wt % to 50 wt %. The particulate matter may be biochar, crumb rubber, or reclaimed carbon obtained via pyrolysis and optional grinding, milling and/or other processing of tires or plastics. Additional particles that may be used include but are not limited to silica (fumed, precipitated, or in other forms), alumina, iron or iron oxide compounds, calcium carbonate, clays, mineral silicates, alkali silicates, sand (e.g., containing at least 50% silica), charcoal fines, coal fines, and carbon black. The particulate matter may be dispersed in the feedstock using conventional equipment such as a homogenizer, rotor stator mill, media mill, hammer mill, agitator, etc. The particulate matter may be initially dispersed in a slurry and then let down with the desired feedstock to a particular concentration. Without being bound by any particular theory, it is believed that the use of particulates in combination with liquid feedstock can reduce coke deposition.

As noted above, the process begins by injecting a gas stream, e.g., carrier gas 15, into plasma zone 10. The carrier gas 15 may be at any typical pressure for preparing carbon black, e.g., from 0.5 to 2 bar (absolute). Lower pressures may also be used. The flow rate of carrier gas 15 may be adjusted to maintain a stable and controllable plasma as is known to those of skill in the art. Carrier gas 15 may be preheated prior to injection into plasma zone 10. For example, a gas stream for use in hot carrier gas may be passed through a heat exchanger or heated electrically prior to injection into plasma zone 10. For example, heat from processing of smoke stream 40 may be transferred to carrier gas 15 in a heat exchanger 72 (FIG. 2) similar to any of those described in US2024279480 or U.S. Pat. No. 8,871,173, the entire contents of which are incorporated herein by reference. Alternatively or in addition, a heat exchanger may receive hot gases from combustion processes associated with downstream processing of smoke stream 40. The carrier gas 15 may be preheated via regenerative cooling of the process equipment. Exemplary methods of regenerative cooling are described in U.S. Pat. Nos. 5,997,837, 10,618,026, and DD211457, the entire contents of which are incorporated by reference. Any conventional method of electrically heating gases may also be used to preheat carrier gas 15, for example, Joule heating using a heating element in contact with carrier gas 15, or using techniques described in US2008226538 or U.S. Pat. No. 11,926,743, the entire contents of which are incorporated herein by reference. Carrier gas 15 may be preheated to any desired temperature, for example, from 100 degC to 1200 degC, from 200 degC to 500 degC, from 500 degC to 1000 degC, or from 400 degC to 1100 degC.

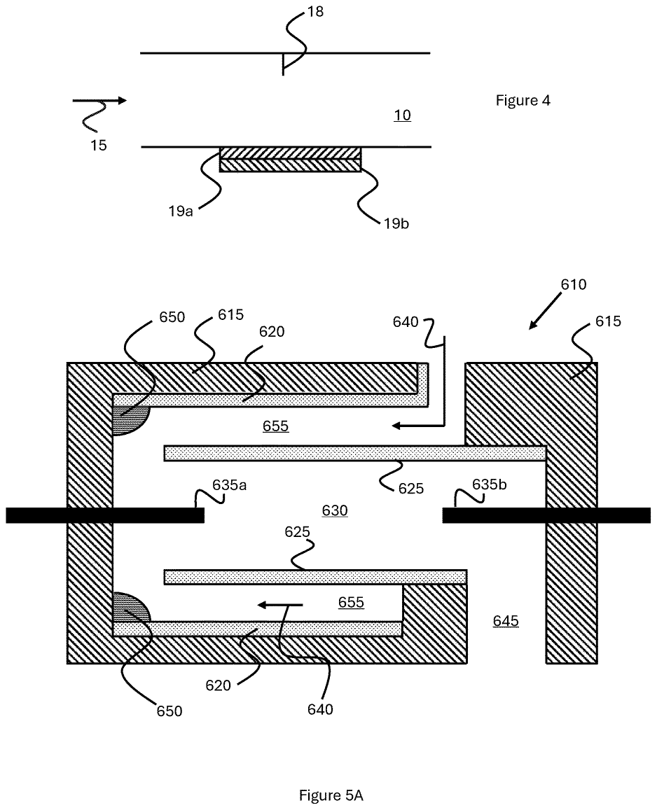

A plasma is used to heat carrier gas 15 in plasma zone 10. Two or more plasma zones 10 may be used to heat carrier gas 15, as shown in FIG. 3. The plasma may be generated using an electric arc, microwave energy, a plasmatron, corona discharge, or any other suitable method, such as those described in Boulos, et al., Handbook of Thermal Plasmas, Vol 1; Springer Nature: Cham, Switzerland, 2023. In certain embodiments, the plasma is generated using an electric arc. The electric arc may be generated using direct current (DC) or alternating current (AC). Multiple torches may be present in a single plasma zone 10, for example, as described in U.S. Pat. No. 10,370,539, the entire contents of which are incorporated herein by reference. For example, a gas stream may be passed over the surface of a plasma electrode as it is introduced into plasma zone 10. An exemplary configuration is disclosed in U.S. Pat. No. 10,716,199B2, the entire contents of which are incorporated herein by reference. The gas may be a component of carrier gas 15 or may include more than one component of carrier gas 15. For example, all the gas streams fed into plasma zone 10 may have the same or different compositions, provided that the mixture of the hot carrier gas and feedstock 30 can have the desired H:C ratio. A bypass flow, such as that described in U.S. Pat. Nos. 6,069,339, 5,925,267 or 5,317,126, the entire contents of which are incorporated herein by reference, may be used to introduce a gas stream as a portion of the gas used in carrier gas 15. In any of these embodiments, these additional gases become combined with other hot gases in plasma zone 10 and become part of hot carrier gas 15.

The arc plasma may be transferred or non-transferred. A transferred arc system uses an electrical arc formed between a traditional electrode that serves as the cathode and a target material that serves as the anode. Suitable transferred arc systems are well described in Boulos, 2023, and are commonly used in scrap metal refining. Alternatively or in addition, a transferred arc (FIG. 4) could be used with a cathode 18 and compressed bed 19a of a carbonaceous material, for example, reclaimed carbon from tire pyrolysis, carbon black, graphite, biochar, or metallurgical coke, serving as the anode bed. Alternatively or in addition, a molten bed 19b may be used as the anode bed or underneath a carbonaceous anode bed. For example, silicon, iron, aluminosilicates, yttria-stabilized zirconia, molten salt, and non-toxic metals that do not generate significant amounts of volatiles and that conduct electricity at temperatures above 1000 degC may be used as the anode bed, with or without an overbed of carbonaceous material. Such transferred arc systems may be used in a horizontal or vertical configuration. For example, carrier gas 15 may be delivered to plasma zone 10 having a transferred arc from a direction roughly transverse to the arc or roughly along the same axis as the arc.

Alternatively or in addition, the electrodes may be continuously fed into plasma zone 10. This may extend the continuous operating capability of plasma carbon black reactor 5 by eliminating or reducing the need to suspend operation to replace electrodes. For example, a packing gland or other suitable seal may be used to seal passage of the electrodes into plasma zone 10 from the exterior of plasma carbon black reactor 5. The electrodes may be graphite, metal, or any other suitable material. Continuously fed electrodes may be used with a transferred arc such as that shown in FIG. 4 or a non-transferred arc.

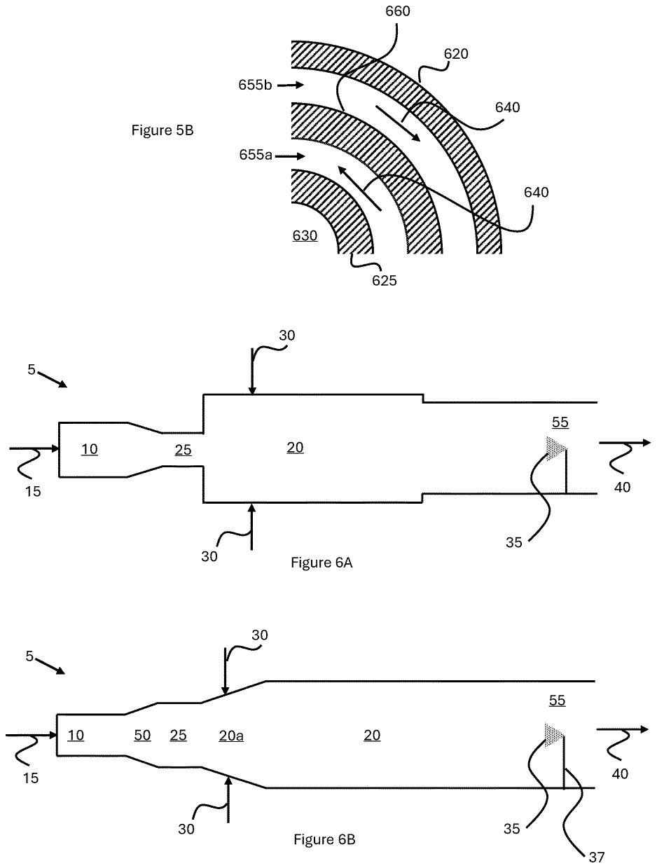

In one embodiment, shown in FIG. 5A, a plasma zone 610 has a refractory wall 615 and an optional outer liner 620. An inner wall 625 defines plasma zone 630 in which an arc is generated between electrodes 635a and 635b. A plasma formed between electrodes 635a and 635b radiates electromagnetic energy to the inner wall 625, heating it. Carrier gas 640 passes between outer liner 620 (or refractory wall 615 in the absence of outer liner 620) and inner wall 625 to enter plasma zone 630. Carrier gas 640 extracts the heat from both surfaces of inner wall 625 and passes out of plasma zone 630 via passageway 645. The use of protrusions such as ribs or fins on the outermost side of inner wall 625 may further promote heat transfer to carrier gas 650. The hot carrier gas 640 may proceed to a reactor zone, sometimes termed a reaction zone, for example, reactor zone 20, or reactor zones 120 or 220 as described elsewhere herein. As an option, one or both of electrodes 635a and 635b are continuously fed into plasma zone 630. Alternatively or in addition, the arc is a transferred arc and electrode 635a is an anode bed of compressed carbonaceous material, molten material, or both, as described above. Alternatively or in addition, carrier gas 640 is swirled as it enters plasma zone 630. For example, a baffle or swirl vane 650 may induce swirl to carrier gas 640 as it enters plasma zone 630, improving the transfer of heat from inner wall 625 to carrier gas 640. As an option, a transition from gap 655 between outer liner 620 and inner wall 625 may be configured to force tangential flow of carrier gas 640 in plasma zone 630. Swirl may alternatively be introduced using any configuration known to those of skill in the art. As an option, an additional wall 660 may be disposed between outer liner 620 (or refractory wall 615 in the absence of outer liner 620) and inner wall 625 to separate gap 655 into two gaps 655a and 655b (FIG. 5B). Carrier gas 640 flows in one direction in gap 655a and in the opposite direction in gap 655b.

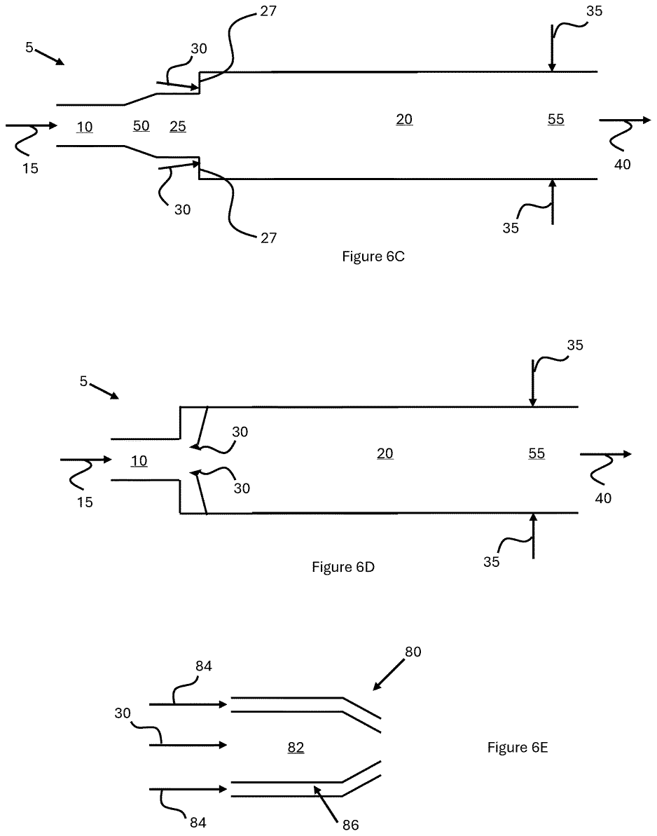

The heated gas proceeds downstream to reactor zone 20. Preferably, the hot carrier gas 15 passes through a region of narrower diameter, for example, throat 25, before passing into reactor zone 20. Alternatively or in addition, a diameter of plasma zone 10 decreases as the heated gas proceeds from plasma zone 10 to throat 25 or reactor zone 20 (FIG. 6A). Alternatively or in addition, a diameter of plasma zone 10 may increase, for example, as in diffuser 50 in FIG. 1, as hot carrier gas 15 proceeds from plasma zone 10 to throat 25. Preferably, reactor zone 20 has a greater diameter than throat 25. The progression from the diameter of throat 25 to the diameter of reactor zone 20 may be gradual, e.g., involving an intermediate zone 20a of gradually increasing diameter (FIG. 6B), or abrupt as in FIG. 1. Where no throat is present, a diameter of reactor zone 20 may be the same or greater than a diameter of plasma zone 10 and/or than a decreased diameter section of plasma zone 10. The progression from the diameter of plasma zone 10 or a decreased diameter section of plasma zone 10 to the diameter of reactor zone 20 may be gradual or abrupt. Reactor zone 20 preferably has a circular cross-section.

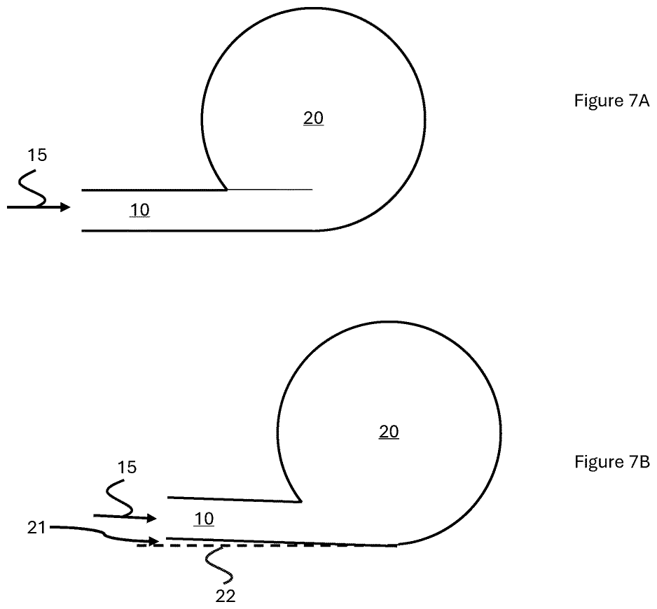

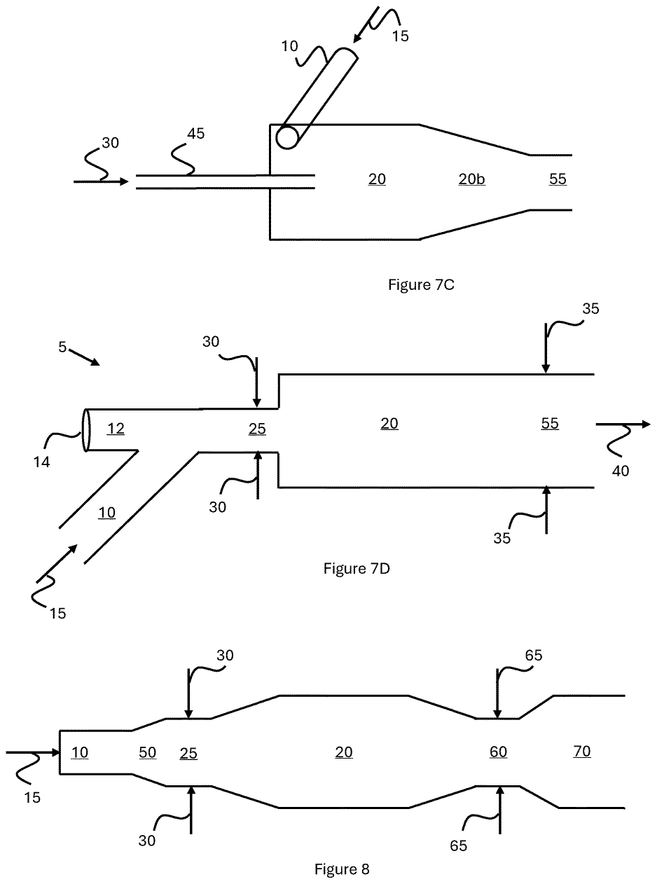

In FIG. 1, the hot carrier gas 15 is introduced to reactor zone 20 along a central axis of reactor zone 20. That is, the flow of hot carrier gas is coaxial with the longitudinal axis of reactor zone 20. FIG. 7A exhibits an alternative configuration in which hot carrier gas 15 is introduced from plasma zone 10 at a tangent to the wall of reactor zone 20 (reactor zone 20 is shown along the longitudinal axis). FIG. 7A shows a cross-sectional view of reactor zone 20 to illustrate how the hot carrier gas 15 is introduced tangentially to reactor zone 20. In this embodiment, hot carrier gas 15 may be introduced at a wall of reactor zone 20 at an angle 21 that is within 10 degrees, for example, within 5 degrees or within two degrees or within 1 degree, of a tangent 22 to the wall of reactor zone 20 (FIG. 7B). The tangential introduction may also be at an angle that is from 45 to 90 degrees with respect to a longitudinal axis of reactor zone 20 (that is, perpendicular or aimed at an angle downstream). As shown in FIG. 7C, no throat 25 is employed in this configuration. We have discovered that such a tangential configuration can retard fouling of the reactor, e.g. via deposition of coke on the walls of reactor zone 20, while reducing the gas traffic required to produce carbon black.

Alternatively, plasma zone 10 may connect to a secondary tube 12 that provides a conduit to throat 25 or reactor zone 20 (FIG. 7D). By placing plasma zone 10 off-axis with respect to reactor zone 20, sight port 14 can be placed in line with the longitudinal axis of reactor zone 20 while permitting axial introduction of hot carrier gas 15.

The carbon black-yielding feedstock 30 is combined with the hot carrier gas 15 in reactor zone 20. The rate of feedstock addition is selected to control the morphology of the resulting carbon black. For a fixed flow rate of carrier gas 15 and power input to a plasma in plasma zone 10, an increased feedstock rate will decrease reactor temperature and surface area, while decreasing the feedstock addition rate increases reactor temperature and surface area. The addition rate of feedstock 30 should be sufficient to allow for a desired gas traffic and a desired rate of carbon black production. An upper limit on the feedstock addition rate is dictated by the reactor temperature. It takes heat to drive pyrolysis, but also to vaporize feedstock. If there is too much feedstock relative to the heat content of hot carrier gas 15, the reactor will be too cold for pyrolysis to proceed. The carbon black yielding feedstock 30 may be introduced into plasma carbon black reactor 5 in any suitable method. For example, in FIG. 1, feedstock 30 is introduced into throat 25 via one or more radial injectors or lances arranged on the circumference of throat 25. Alternatively or in addition, feedstock 30 may be introduced via such radial injectors or lances but in reactor zone 20 (as shown in FIG. 6A), downstream of throat 25 or plasma zone 10. Such radial injectors may direct feedstock from a wall of reactor zone 20 or may project into reactor zone 20. For example, a single injector may extend halfway (i.e., half the diameter) into reactor zone 20 or a plurality of injectors may each extend less than halfway into reactor zone 20. Such injector(s) may be perpendicular to the longitudinal axis of reactor zone 20 or may be disposed at a small angle either upstream or downstream (FIG. 6D). Alternatively, or in addition, feedstock 30 may be introduced via axial injectors from a downstream face 27 of throat 25 (FIG. 6C). Such axial injectors may direct feedstock 30 parallel to a longitudinal axis of reactor zone 20 or at an angle. For example, feedstock 30 may be directed at an angle from 0.5 deg to 15 deg from parallel towards the central axis of reactor zone 20.

In any of these embodiments, feedstock 30 may be introduced using a bifluid nozzle, for example, bifluid nozzle 80 (FIG. 6E), via which a gas is co-injected with feedstock 30 to promote atomization of the liquid feedstock 30. Typically, the feedstock is fed through a central portion 82 of the bifluid nozzle, with the gas 84 introduced via a sheath or annulus 86 surrounding the central portion 82. The gas 84 may be any of the gases listed herein for carrier gas 15 and other uses of gas elsewhere in the process and may be the same or different than the carrier gas 15. The gas 84 injected with liquid feedstock 30 becomes part of the mixture of hot carrier gas 15 and feedstock 30. Thus, the gas composition should enable the desired H:C ratio to be maintained. Alternatively, feedstock 30 may be injected via a single fluid nozzle, or, where appropriate, a venturi nozzle. Feedstock 30 may be introduced into plasma carbon black reactor 5 in one location or in multiple locations; e.g., multiple distances from plasma zone 10. Where the progression to the diameter of reactor zone 20 from the upstream portions of plasma carbon black reactor 5 is gradual, the circumferential introduction may be in a portion of plasma carbon black reactor 5 where the diameter is changing (FIG. 6B), in a portion of constant diameter, or both. In an alternative embodiment, as shown in FIG. 7B, the hot carrier gas is introduced tangentially into reactor zone 20 and a central lance or pipe 45 (FIG. 7C) positioned approximately on the centerline of reactor zone 20 is used to direct feedstock 30 into reactor zone 20. The central lance or pipe 45 may have an injector head having one, two or more holes around the tip or a spray head. In any of these embodiments, the feedstock may be preheated according to any suitable method, for example, as described in U.S. Pat. No. 8,871,173 or US2008226538, the entire contents of which are incorporated herein by reference.

Following any optional expansion of diameter at its upstream end, reactor zone 20 may have a constant diameter until quench spray 35 (FIG. 6B) or may have an area of decreasing diameter 20b leading to a quench zone 55 having a smaller diameter than the maximum diameter of reactor zone 20 as shown in FIG. 7B. Alternatively or in addition, reactor zone 20 may have a downstream area 20c with increased diameter, as shown in FIG. 1. As the blend of hot carrier gas 15 and feedstock 30 travels downstream, the feedstock 30 is converted to carbon black and gases such as hydrogen, carbon monoxide, carbon dioxide, water, H₂S and/or SOₓ (if sulfur is present in the feedstock), and other typical gaseous products of carbon black production, for example, CH₄, C₂H₂ COS, CS₂, NO, NO₂, HCN, and NH₃. Quench spray 35 may be water and/or a cold gas, or a liquified gas such as liquid nitrogen. The quench spray may be introduced in a single location as shown in FIG. 1 or in multiple locations as described, for example, in U.S. Pat. No. 6,153,684, the entire contents of which are incorporated herein by reference. For example, the operator may spray one water stream in one location, and the balance of the water downstream at a second location, in order to achieve specific particle properties Alternatively or in addition, the reaction may be quenched via heat exchange using a quench boiler. Alternatively or in addition, a chemical quench method can be used; for example, the injection of CH₄, when water vapor is present, can remove heat chemically as it reacts to form CO and H₂. Any other suitable method of quenching the mixture of hot carrier gas 15, carbon black, and other gases may also be employed. The quench spray may be injected roughly along a central axis of plasma carbon black reactor 5, as shown in FIG. 6B, or radially from a plurality of locations as shown in FIG. 6C. The quench spray 35 may alternatively be injected radially using a plurality of elements similar to element 37 in FIG. 6B but extending less than half way across quench zone 55.

The length of reactor zone 20 may be at least twice the diameter of throat 25, if used, or at least twice the narrowest diameter of any portion of plasma carbon black reactor 5 in the absence of a throat, for example, from two times the diameter to 100 or 200 times the diameter, for example, from 2 times the diameter to 5 times the diameter, from 5 times the diameter to 10 times the diameter, or from 10 times the diameter to 50 times the diameter. The length of reactor zone 20 may be adjusted to control one or more of carbon black surface area measured by iodine number (according to ASTM D1510) or nitrogen surface area (according to ASTM D6556), toluene extractable content (ASTM D1618), the ratio of surface area measured as STSA (statistical thickness surface area according to ASTM D6556) to surface area measured as nitrogen surface area, pH (as measured according to ASTM D1512), a degree of graphitization of the carbon black (e.g., as measured by Raman spectroscopy, e.g. crystallite size La and/or the intensity ratio between the D and G bands, via x-ray diffraction, e.g., crystallite size La or Lc, see Kelesidis, et al., Carbon, (2022) 197:334-340 and WO2017136196, the entire contents of both of which are incorporated herein by reference), or water spreading pressure, for example, as described in U.S. Pat. No. 8,574,537, the entire contents of which are incorporated herein by reference. A maximum length of reactor zone 20 may be determined by cooling of the mixture of hot carrier gas 15, carbon black, and other gases. As heat is lost from plasma carbon black reactor 5, there is not sufficient energy to promote further pyrolysis of the feedstock 30 and formation of carbon black, especially at lengths beyond 100 or 200 feet. The reactor zone may be actively cooled, with water, an alternative liquid coolant, or a gas, as is known in the art. The reactor zone 20 and other parts of plasma carbon black reactor 5 may also be refractory-lined, to reduce the rate of heat loss to the coolant without exceeding the service temperature limit of its inner wall. The reactor zone 20 and other parts of plasma carbon black reactor 5 can also be refractory-lined without resort to active cooling, depending on the reactor temperature, the rate of heat transfer, and the refractory material.

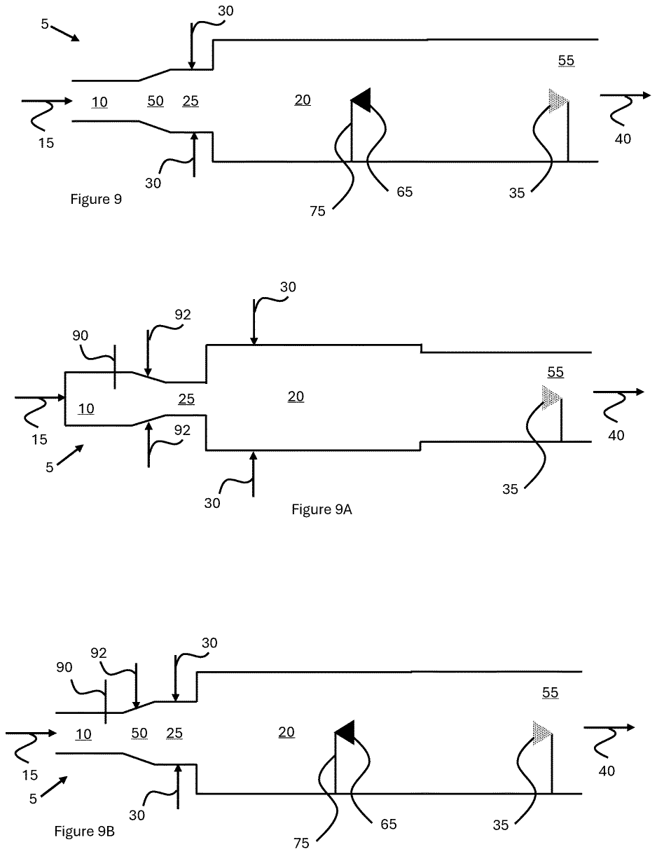

In some embodiments, one or more additional feedstock streams are provided downstream from injection of feedstock 30. For example, a second throat 60 may be provided (FIG. 8) for injection of second feedstock 65, followed by a second reactor zone 70. Second feedstock 65 may be injected radially from the walls of second throat 60 (FIG. 8) or axially from a downstream face of throat 60 similar to axial introduction of feedstock 30 from a downstream face 27 of throat 25 as shown in FIG. 6C. Alternatively or in addition, there is no downstream contraction in reactor zone 20 and the feedstock is injected radially from the walls or using an element 75 extended into the interior of reactor zone 20 as shown in FIG. 9. The diameter of the first and second throats may be the same or different. The diameters of the first reactor zone 20 and second reactor zone 70 may be the same or different. Where a second throat is not used, as in FIG. 9, reactor zone 20 may increase or decrease in diameter following or in the same plane as introduction of second feedstock 65. The diameter of first reactor zone 20 may decrease gradually as the mixture of hot carrier gas 15 and the reaction products formed in first reactor zone 20 (e.g., solid carbon and gases formed during the production of carbon black) travels to second throat 60. Introduction of second feedstock 65 may be accomplished using a bifluid nozzle as described above, a venturi element, a single fluid nozzle, or using any other apparatus known to those of skill in the art. A quench stream may be introduced between the introduction of the first and second feedstock to adjust the temperature of the reacting mixture of hot carrier gas 15 and feedstock, e.g., feedstock 30, to control the temperature for the desired action of the second feedstock, e.g. the building of carbon black structure as described in U.S. Pat. No. 7,829,057, the entire contents of which are incorporated herein by reference, or the manipulation of other elements of carbon black morphology.

Alternatively or in addition, particles may be introduced into plasma carbon black reactor 5 as a separate stream. For example, particles may be introduced in plasma zone 10 or in reactor zone 20. The particles may be any of the particles described in connection with feedstock particle blends herein. In some embodiments, particles may be introduced into hot carrier gas 15 in the same manner as described in U.S. Pat. No. 10,519,298, the entire contents of which are incorporated by reference herein. In some embodiments, particles may be combined with the carbon black forming feedstock for injection into plasma carbon black reactor 5, e.g., into plasma zone 10 or reactor zone 20. Alternatively or in addition, particles may be combined with water and fed into plasma zone 10 as an aqueous slurry. Alternatively or in addition, particles may be blended with carrier gas 15 for injection into plasma zone 10 or injected separately into plasma zone 10. The particles may be injected into plasma carbon black reactor 5, e.g., into plasma zone 10 or reactor zone 20, in any manner known to those of skill in the art. For example, the particles can be pumped into the plasma carbon black reactor 5 using any suitable pump for particulates, for example, an air operated diaphragm or double diaphragm pump, a flap valve pump, a centrifugal pump, or a disc pump. Likewise, a loss-in-weight type feeder or augur may be employed. In certain embodiments, no more particle carrier gas is required beyond that which passes through the pump with the particles. The desired composition of the particle carrier gas will depend on the location into which the particles are injected. For example, particles injected separately into plasma zone 10 may still benefit from being carried by a gas having the same or similar composition to carrier gas 15. Particles injected into reactor zone 20 may be carried by any of the gases described separately herein for injection into reactor zone 20. Any alternative means known to those of skill in the art for conveying the particles may also be employed. The particle carrier gas may be preheated by passing it through a heat exchanger or via other methods known to those of skill in the art.

In one embodiment, sand, clay, or other silica-containing particle may be injected into plasma zone 10. Preferably, the silica-containing particle is injected directly into the plasma. Preferably, the silica-containing particle contains at least 50 wt % silica. The silica-containing particle may be fed via lance 90 (FIGS. 9A and 9B) into plasma zone 10. Preferably, the particle carrier gas is inert or has the same composition as carrier gas 15. Alternatively, the silica-containing particle may be combined with water and injected into plasma zone 10 as an aqueous slurry. The energy of the plasma is sufficient to vaporize at least some of the particulate matter and convert it to gaseous SiO and oxygen gas. Alternatively or in addition, waterglass may be injected into plasma zone 10, where at least a portion is converted to gaseous SiO. An additional oxidant gas 92, e.g., a gas comprising one or more of oxygen, carbon dioxide, or water may be injected into plasma zone 10 in one or more locations downstream of the lance, for example, into diffuser 50 or other region upstream of throat 25 or at least upstream of the injection of feedstock 30. The SiO gas reacts with the oxidant to form silica while the feedstock pyrolyzes and reacts to form carbon black as described above. Because both the SiO and feedstock are both being transported by hot carrier gas 15 through reactor zone 20, silica and carbon black form together to produce an aciniform silica-carbon black composite.

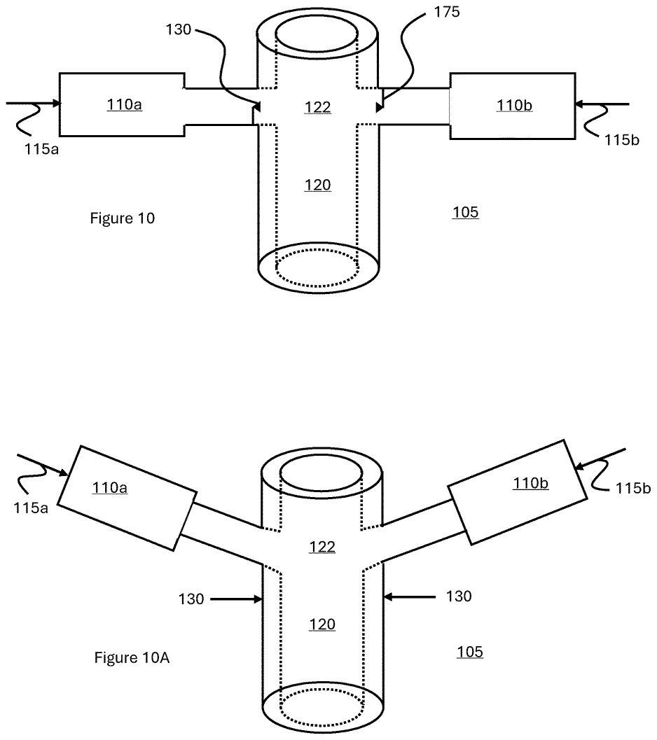

An alternative reactor configuration is shown in FIG. 10. In plasma carbon black reactor 105, carrier gases 115a and 115b are heated to form a plasma in plasma zones 110a and 110b, respectively, and proceed to reactor zone 120. As shown in FIG. 10, the hot carrier gas streams 115a and 115b pass through a zone of decreased diameter to reactor zone 120, but this is optional. Likewise, any of the options for decreasing or increasing the diameter of reactor zone 120 described with reference to plasma zone 10 and throat 25 may be employed in plasma carbon black reactor 105. The resulting configuration is frequently termed an opposed flow and preferably tends to direct hot carrier gas streams 115a and 115b towards a central portion 122 of reactor zone 120, away from the walls. In central portion 122, the hot carrier gas streams merge. Feedstock 130 may be directed into reactor zone 120, for example, from elements 175. Alternatively or in addition, feedstock 130 may be directed into reactor zone 120 in a location that is downstream of reactor zone 120 as shown in FIG. 10A. Feedstock 130 may include any one or more of the carbon black forming feedstocks described elsewhere herein, provide that the desired ratio of H:C is maintained. When reactor zone 120 is oriented vertically as shown in FIG. 10, the resulting carbon black tends to fall downwards from the plasma carbon black reactor. As shown in FIG. 10, the hot carrier gas streams 115a and 115b merge and also mix with feedstock 130 to form a unified mixture of hot carrier gas and feedstock. While FIG. 10 shows the hot carrier gas streams 115a and 115b approaching each other along a single axis perpendicular to reactor zone 120, the two hot carrier gas streams 115a and 115b may also be angled with respect to reactor zone 120 as shown in FIG. 10A. Preferably, the hot carrier gas streams enter reactor zone 120 at an angle of 30 to 90 deg, for example, from 40 to 90 deg, from 50 to 90 deg, from 70 to 90 deg, from 80 to 90 deg, or 90 deg (i.e., perpendicular) with respect to an upstream end of reactor zone 120.

It is also desirable to employ additional or alternative methods of reducing coke deposition. Oxidizing species, such as water, oxygen, carbon dioxide, ozone, atomic oxygen, sulfur dioxide, carbonyl sulfide, oxides of nitrogen, metallic oxides that are vaporous at the high temperature of the reactor, such as MoO₃, OH radicals, or ions of any of these, present in reactor zone 20 can prevent coke formation and/or burn off coke already present in the plasma carbon black reactor. Oxidizing species may come from several sources. The carrier gas 15 may include oxygenous gases (that is, gases containing atomic oxygen) such as water vapor, oxygen, carbon dioxide, ozone, sulfur dioxide, carbonyl sulfide, and/or oxides of nitrogen (e.g., NOₓ). Metal oxides such as molybdenum trioxide that are vaporous at the temperature of the plasma carbon black reactor may also be employed. Such species may be injected into the plasma carbon black reactor in particulate form or sublimated and the resulting gas fed into the plasma carbon black reactor. Alternatively or in addition, any of these species in carrier gas 15 can partially dissociate in the plasma zone. A portion of the resulting oxygen atoms may combine to form oxygen molecules or may proceed to reactor zone 20 in atomic form. Oxygen atoms and/or hydroxide groups in feedstock 30 can dissociate during the pyrolysis and become available to react with coke or with coke-forming species. Indeed, processing and recycling of tail gas present in smoke 40 can result in SOₓ and NOₓ species in carrier gas 15. These species can also dissociate to provide oxygen atoms or may act as oxidants in molecular or ionic form.

Alternatively or in addition, oxygenous gases can also be introduced to reactor zone 20. For example, oxygen gas, either neat or as a mixture with other gases, can be introduced via a low pressure flow through pores in the walls of reactor zone 20. Suitable structures for introducing porosity include those used for transpiration cooling, for example, as described in US20230399999, U.S. Pat. Nos. 6,606,851, 7,128,532, and 6,443,700, the contents of all of which are incorporated herein by reference. In this embodiment, it may only be necessary to provide sufficient pressure to direct the gas into reactor zone 20. Alternatively, an oxygenous gas or blend with a non-oxygenous gas may be injected in a single location or plane in reactor zone 20, as described in U.S. Pat. No. 6,156,837, the entire contents of which are incorporated herein by reference. In this embodiment, it may be desirable to inject the oxygenous gas or blend with sufficient pressure to allow it to mix with the hot carrier gas 15 and reduce recirculation of hot carrier gas 15. The gas for introduction of feedstock 30 using a bifluid nozzle as described above may include one or more oxygenous gases. In any of these embodiments, the oxygenous gas may be heated before introduction to reactor zone 20. In any of these embodiments, it may be desirable to periodically adjust the amount of molecular or atomic oxygen in plasma carbon black reactor 5 or reactor zone 20. Oxidative etching of the carbon black itself can reduce yield. Thus, varying the amount of oxygen or other oxidizing species periodically allows for removal of coke or other fouled material on the walls while reducing the impact on carbon black yield.

Oxygenous gases introduced into plasma carbon black reactor 5, either as part of carrier gas 15 or feedstock 30 or in reactor zone 20 become part of the mixture of hot carrier gas 15 and feedstock 30. The mixture of the feedstock and the hot carrier gas may have an atomic ratio O:C of from 0.05 to 2, for example, from 0.07 to 0.09, from 0.09 to 0.13, from 0.13 to 0.17, from 0.17 to 0.2, from 0.2 to 0.23, from 0.23 to 0.27, from 0.27 to 0.3, from 0.3 to 0.35, from 0.35 to 0.4, from 0.4 to 0.6, from 0.6 to 0.8, from 0.8 to 1, from 1 to 1.2, from 1.2 to 1.4, from 1.4 to 1.6, from 1.6 to 1.8, or from 1.8 to 2. The feedstock may contain at least 0.5 wt % oxygen atoms, for example, from 0.5 wt % to 50 wt %, from 1 wt % to 40 wt %, from 2 wt % to 30 wt %, from 5 wt % to 20 wt %, or from 10 wt % to 15 wt %. The upper limit on feedstock oxygen content may be dictated by the need to have enough carbon to meet the H:C ratio requirements provided elsewhere herein.

Alternatively or in addition, various additional gas streams may be used to reduce wall fouling. In any of these embodiments, the gas may have the same or different composition than carrier gas 15 and may include one or more gases described in connection with carrier gas 15. The gas may include one or more oxygenous gases as described above. For example, an additional gas stream may be introduced to a single location along a wall of reactor zone 20, as described in U.S. Pat. No. 6,156,837, the entire contents of which are incorporated herein by reference, at enough pressure to reduce recirculation of hot carrier gas 15. Alternatively or in addition, an additional gas stream may be introduced via a low pressure flow through pores in the walls of reactor zone 20 to provide transpiration cooling, for example, as described in US20230399999, U.S. Pat. Nos. 6,606,851, 7,128,532, and 6,443,700, the contents of all of which are incorporated herein by reference. In any of these embodiments, the additional gas stream becomes part of the mixture of the feedstock and the hot carrier gas; therefore its composition should be controlled to maintain the H:C ratio, and preferably the O:C ratio, discussed elsewhere herein.

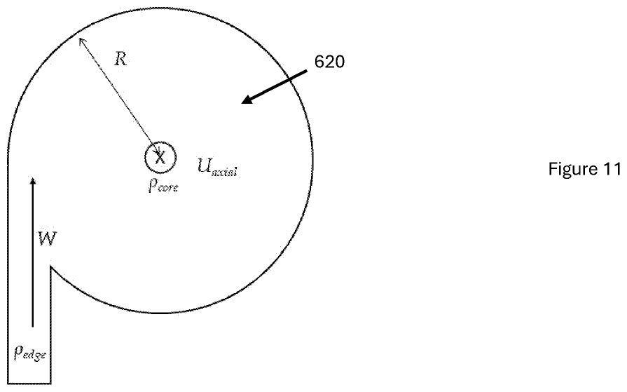

Alternatively or in addition, wall fouling may be retarded by introducing an additional gas stream as a high velocity swirled gas sufficient to create stratified flow relaminarization as described in Beér and Chigier (Beér, J M and Chigier, N A. Combustion Aerodynamics. Robert E. Krieger Publishing Company, Malabar, FL, 1983, p. 136-144, the entire contents of which are included herein by reference). At least a portion of the additional gas stream becomes part of the mixture of the feedstock and the hot carrier gas; therefore its composition should be controlled to maintain the H:C ratio, and preferably the O:C ratio, discussed elsewhere herein. Stratified flow relaminarization can occur when the centrifugal acceleration caused by rotating flow layers forces the lower-density, more buoyant flow in the core of a cylinder or tube to stay in the center. Mixing between the outer flow and the inner core flow is slowed, as the centrifugal force counters the shear mixing. Such a gas is typically introduced tangentially to create radially stratified flow relaminarization, such as described in U.S. Pat. No. 5,411,394, the entire contents of which are incorporated herein by reference. The criteria for the onset of rotation-induced or swirl-induced flow stratification is usually a modified Richardson number. The Richardson number is a dimensionless number that gives the ratio of buoyancy-driven acceleration to shear acceleration. When it is large, the flow stratifies (the light and heavy portions begin to separate into layers) and the flow resists shear mixing in this location. The modified Richardson number replaces gravitational acceleration with centrifugal acceleration and is appropriate for industrial flames and reactors such as those in the present embodiments where gravity can be neglected. The modified Richardson number can be expressed as Beér and Chigier do

$${Ri}^{*} = \frac{( 1 / ρ ) ( \partial ρ / \partial r ) ( {W}^{2} / r )}{{( \frac{\partial {U}_{axial}}{\partial r} )}^{2}}$$

where W is the tangential component of the velocity vector and Uₐₓᵢₐₗ is the axial velocity, assuming a tubular reactor shape. As described in U.S. Pat. No. 5,411,394, swirled flow can begin to induce stratification when Ri*>0.04. When the reaction zone, e.g., reactor zone 620, is a tube, cylinder, or expanding cone, with a central core flow, as sketched in FIG. 11, then the above expression can be estimated in the following way:

$${Ri}^{*} \approx \frac{( 1 / {ρ}_{core} ) ( Δρ / R ) ( {W}^{2} / r )}{{( \frac{{U}_{axial}}{R} )}^{2}}$$

In FIG. 11, a core flow with a density of ρcore<ρedge travels axially (into the page) while a tangential flow swirls around it. The core flow has an axial velocity of Uaxial while the edge flow has a tangential velocity component of W, and a density ρedge. The radius is R. Δρ is the density difference ρedge−ρcore, which must be positive, and usually is when the core flow is hot and reacting. The flow will tend to stratify—that is, flow packets from the core will resist mixing with the flow packets near the edge—when Ri*>0.04 (in some cases) and reliably when Ri*>1. Table 1 presents an example calculation. Stratification in this way can help keep reacting feedstock away from the walls of the reaction zone, e.g., reactor zone 620 and prevent the resultant sticky, partially-formed carbon black particles from reaching the reactor walls before they are finished dehydrogenating.

TABLE 1

| | | |
|---|---|---|
| Reactor radius | m | 0.5 |
| Tangential Velocity W | m/s | 150 |
| Core Axial Velocity U | m/s | 75 |
| Core Density | kg/m³ | 0.21 |
| Edge Density | kg/m³ | 0.33 |
| Ri* | num | 2.21 |

Alternatively or in addition, a lower velocity swirled gas, introduced tangentially, can still sweep the walls and retard fouling, even if the swirl number or tangential momentum is insufficient to create stratified flow as described above. Such a lower velocity swirled gas may be introduced at one or more locations along reactor zone 20. The lower velocity swirled gas becomes part of the mixture of the feedstock and the hot carrier gas; therefore its composition should be controlled to maintain the H:C ratio, and preferably the O:C ratio, discussed elsewhere herein.

Alternatively or in addition, an abrasive may be periodically propelled at high velocity into plasma carbon black reactor 5 to remove buildup on the walls, e.g., of plasma zone 10 and/or reactor zone 20. Any suitable abrasive, e.g., zirconia, may be used; one of skill in the art will recognize that the abrasive should be selected to optimize removal of deposited material while minimizing damage to the reactor wall. Such blast cleaning, or shot cleaning, may be performed during production or during breaks in carbon black production. By selecting an abrasive particle sufficiently larger (e.g., diameter of at least 100 microns) and denser than carbon black, the abrasive particles can easily be separated from the carbon black by conventional classification methods. The abrasive particles can optionally be recovered after use by burning off any attached coke and other foulant material removed from plasma carbon black reactor 5.

Reducing coke deposition using one or more of the techniques provided herein can increase the efficiency of carbon black manufacturing and extend the time before carbon black manufacturing has to be stopped because plasma carbon black reactor 5, especially reactor zone 20, has become too fouled to operate as desired. The techniques provided herein limit the degree and rate to which solid carbon, particularly in the form of coke or carbonaceous deposit, may build up in a plasma carbon black reactor, e.g., plasma carbon black reactor 5, during operation, as opposed to leaving the plasma carbon black reactor with the smoke, e.g., smoke stream 40. Specifically, they allow for continuous operation in which the mass ratio of solid carbon that builds up in the plasma carbon black reactor over a period of 8 hours with respect to the particulate carbon that leaves plasma carbon black reactor 5 as part of smoke 40 over the same time period is no greater than 0.5%.

Some of the embodiments provided herein can also reduce grit formation during carbon black manufacture. Grit is composed of impurities having a significantly larger size than the carbon black particles, generally considered to be materials that can be retained on a 325 mesh (44 micron) screen. Even though such materials may be carbonaceous, the discrepancy in particle characteristics from carbon black can be detrimental to performance of final products such as tires. The techniques described above to reduce coke deposition can also reduce grit formation. In preferred embodiments, a ratio of grit/carbon black produced over at least an hour, for example over a four or eight hour period of continuous operation, measured once per hour, averages no more than 2400 ppm, by mass for example, from 50 ppm to 2200 ppm, from 100 ppm to 2000 ppm, from 150 ppm to 1500 ppm, from 200 ppm to 1000 ppm, or from 500 ppm to 1200 ppm.

It is further desirable to reduce the energy input required to make carbon black having a desired surface area. In some embodiments, the net energy to produce 1 kg carbon black is at most 20 kWh/kg, for example, at most 9 kWh/kg, at most 6 kWh/kg, or from 1 kWh/kg to 5 kWh/kg. For example, when hot carrier gas 15, before or after mixing with feedstock, is introduced to reactor zone 20 along with a longitudinal axis of plasma carbon black reactor 5 or reactor zone 20, the net energy Q in kWh to produce 1 kg carbon black may be no greater than 6 for carbon black having an iodine number less than 100 mg/g and may satisfy I2No≥7Q+58 for carbon black having I2No of 100 mg/g or greater. Iodine number is measured according to ASTM D1510. The use of tangential introduction of hot carrier gas 15, as in FIG. 7, may result in a reactor operation satisfying 12No≥21Q−124. In some embodiments for either of these configurations, net energy input is at most 9 kWh/kg carbon black or at most 6 kWh/kg carbon black. Net energy is calculated as the total electrical energy input less cooling losses.

Cooling losses are determined in one of the following two ways. First, when the outside of a vessel is actively cooled by passing air, water, or another fluid over its outer surface, the inlet and outlet temperatures of the coolant are measured. The flowrate of the coolant is measured and the heat capacity of the coolant over this temperature range is measured or more typically, already known. From these measurements one skilled in the art may determine the rate at which heat is lost to the coolant from the plasma carbon black reactor. This is the “cooling loss”.

Alternatively, if the outside of the vessel is not subjected to intentional convective cooling, the cooling loss is estimated, using the methods for calculating heat transfer by natural convection, as described in Perry, R. H. and Green, D. W. Perry's Chemical Engineer's Handbook, 7^{th} Edition. New York: McGraw-Hill, 1997, pages 5-13 to 5-14, the entire contents of which are incorporated herein by reference. For example, if the reactor is the most common geometric shape—a horizontal cylinder—then the Churchill-Chu correlation (Churchill, S. W.; Chu, H. H. S. Int. J. Heat Mass Transfer 1975, 18, 1049-1053) may be used to estimate the heat transfer from the reactor outer wall to the atmosphere by natural convection. To use this equation, the experimenter must know the temperature of the ambient air, and estimate or measure the temperature of the reactor outer surface. Then the Churchill-Chu correlation may be used to estimate the Nusselt number Nu:

$${Nu}^{1 / 2} = 0.6 + 0.387 {( \frac{Ra}{{[ 1 + {( 0.559 / Pr )}^{9 / 16} ]}^{16 / 9}} )}^{1 / 6}$$

$$Nu = \frac{hL}{k}$$

$$Ra = GrPr$$

$$Pr = \frac{{C}_{P} μ}{k}$$

$$Gr = \frac{g β ( {T}_{S} - {T}_{∞} ) {L}^{3}}{{v}^{2}}$$

where
Nu is the Nusselt number
h is the heat-transfer coefficient (W/m²-K)
L is the diameter of the cylinder shape (m)
k is the thermal conductivity of air (W/m-K)
g is the acceleration of gravity, 9.8 m/s²
Ra is the Rayleigh number
Pr is the Prandtl number
C_{P} is the constant-pressure heat capacity of air at T_{∞}, (K)
T_{∞} is the bulk temperature of the surrounding air (K)
T_{S} is an average or characteristic surface temperature of the cylinder (K)
μ is the air viscosity (Pa-s)
ρ is the air density at T_{∞} (kg/m³)
v is the kinematic viscosity of the air at T_{∞} (m²/s)
β is the volume expansion coefficient for air, which can be approximated as 1/T_{∞} (1/K)
   The rate of heat loss from the reactor walls is then calculated by

Q=hA(T_{S}−T_{∞})

where Q=rate of heat transfer in W and A is the outer area of the cylinder. Normally, when water cooling or active cooling is used, passive cooling by natural convection can be ignored. For other shapes, such as a vertical cylinder, a practitioner can use the correlation from Perry, R. H. and Green, D. W. Perry's Chemical Engineer's Handbook, 7^{th} Edition p. 5-13 to 5-14:

Nu=0.138Gr^{0.36}(Pr^{0.175}−0.55)
when Gr≥1E09 and

$$Nu = 0.683 {Gr}^{0.25} {{Pr}^{0.25} [ \frac{Pr}{0.861 + Pr} ]}^{0.25}$$

when Gr<1E09.

Alternatively or in addition, it is desirable to reduce the gas traffic required to make carbon black. Gas traffic is defined as the total amount of gas, in kmols, present per kg of carbon black, at the point just before any quench media is introduced. It is calculated by adding the amount of non-reacting carrier gas to the total amount of gases created by the reaction of feedstock to either carbon black, or other species. The amount of non-reacting carrier gas added to the plasma carbon black reactor is tracked during operation. Estimation of the total amount of gas created by reaction of the feedstock requires some assumptions, and there are multiple reasonable methods known in the art.

A common practice is to start with an estimate or measurement of the carbon black yield. The yield is the mass of carbonaceous solids (e.g., carbon black, plus any amounts, which are preferably small, of grit and coke) produced per mass of feedstock used, expressed typically as kg carbon/kg feedstock. Once the yield is known, or estimated, it is then assumed that a portion of the feedstock will become carbon black, according to the equation:

CₓH_{y}N_{z}OₐS_{b}→xC(s)+(y/2−a−b)H₂ (g)+(z/2)N₂ (g)+aH₂O (g)+bH₂S (g)

where CₓH_{y}N_{z}OₐS_{b} is an empirical formula for the carbon black feedstock. The progress of the reaction is set such that the amount of C(s) produced matches the measured or estimated yield. The remaining amount of CₓH_{y}N_{z}OₐS_{b} does not form solid carbon—it is assumed to form small gas-phase molecules. These are typically H₂, CO, CO₂, CH₄, C₂H₂ and H₂O but can include many other small gas phase molecules in small amounts, such as COS, CS₂, H₂S, SOₓ, NO, NO₂, HCN, and NH₃.

Next, the practitioner uses one of two methods to estimate the production of gas-phase species from the remaining CₓH_{y}N_{z}OₐS_{b} that did not progress to make C(s) and its byproducts by the above reaction. It is in nearly all cases not material to the calculation of gas traffic, which of these methods is used.

The first method is termed the “partial equilibrium” method and is well known in the art. This method assumes that all gas-phase species will be in equilibrium at a specified reactor temperature. This reactor temperature is determined by iteratively solving an enthalpy balance around the reactor system, combined with the solution of the gas-phase chemical equilibrium problem. Many computer algorithms exist for this calculation. Solving the combined chemical equilibrium and enthalpy problem gives concentrations for all the small-molecule gases produced from the CₓH_{y}N_{z}OₐS_{b}. From this result, it is possible to calculate the amounts of all the gas phase species produced, add them to the non-reacting carrier gas amounts, and then evaluate the gas traffic.

An alternative method known to those of skill in the art is called the “predefined reaction” method. In it, the practitioner estimates the amounts of small molecule species produced by assuming specific reactions go to completion. The CₓH_{y}N_{z}OₐS_{b} that did not form carbon black is assumed to react by a set of rules derived from combustion chemistry. This method is exemplified in the examples below—the example method is suitable when the total mixture of gases is fuel-rich, but some molecular oxygen has been delivered to the plasma carbon black reactor. It is first assumed that all O₂ present will form CO from this remaining amount of CₓH_{y}N_{z}OₐS_{b}. This consumes all the C atoms in the remaining CₓH_{y}N_{z}OₐS_{b}. Any remaining O₂ is assumed to form H₂O from the H in the remaining CₓH_{y}N_{z}OₐS_{b}. This consumes all the H atoms in the remaining CₓH_{y}N_{z}OₐS_{b}. The N in the remaining CₓH_{y}N_{z}OₐS_{b} is assumed to form N₂. The O in the remaining CₓH_{y}N_{z}OₐS_{b} is assumed to form H₂O from H₂ produced in the steps preceding (i.e. from the CₓH_{y}N_{z}OₐS_{b} that formed C(s), H₂, and other gases). The S in the remaining CₓH_{y}N_{z}OₐS_{b} is assumed to form H₂S likewise from H₂ produced in the steps preceding.

These steps result in an estimate of the total amount of N₂, H₂, CO, H₂O and H₂S produced by reactions of the feedstock. These amounts are added to the pre-existing gas traffic of non-reacting species, to form an estimate of the gas traffic. Unlike in the partial equilibrium method, any enthalpy balance that must be solved can be solved separately to determine other parameters such as the theoretical reactor temperature.

The gas traffic is preferably no greater than 1 kmol/kg carbon black, for example, from 0.05 kmol/kg or 0.1 kmol/kg to 1 kmol/kg. Reduced gas traffic further enables the production of carbon black with reduced energy, reducing the energy required to make high surface area carbon black in comparison with alternative plasma processes. In some embodiments where hot carrier gas 15 or the mixture of hot carrier gas 15 and feedstock is introduced to reactor zone 20 along an axis aligned with a longitudinal axis of plasma carbon black reactor 5 or reactor zone 20, the gas traffic satisfies I2No≥188 (gas traffic)−8. The use of tangential introduction of hot carrier gas 15, as in FIG. 7, may result in a reactor operation satisfying I2No≥142*gas traffic−22, where iodine number is given in mg/g and gas traffic is given in kmol/kg C.

Carbon black may be recovered from smoke stream 40 using any conventional cooling and separating means. Separation of carbon black out of smoke stream 40 is readily accomplished by conventional carbon black separators such as a precipitator, cyclone separator, bag filter, electrostatic precipitator, ceramic or metal filter, or other means known to those skilled in the art. The remaining tail gas following separation of the carbon black contains hydrogen, water, and optionally oxygen, carbon monoxide, and other combustible species generated during carbon black formation, along with gas species originally introduced to plasma carbon black reactor 5 in carrier gas 15. If water was used for quenching, the tailgas also has substantial water vapor. The tail gas may also contain trace sulfur and/or nitrogen species such as SOₓ (including SO₂), NOₓ, HCN, H₂S, etc.

The tail gas may be processed by any method known to those of skill in the art. The tail gas may be processed as described in US2024279480, the entire contents of which are incorporated by reference. The tail gas may be processed as described in U.S. Pat. No. 7,666,383, the entire contents of which are incorporated herein by reference, for example, using one or more of a shift reactor (e.g., to convert CO to carbon dioxide), scrubbers, pressure swing absorbers, membranes, and other devices known to those of skill in the art to recover hydrogen and carbon dioxide from the tail gas. The hydrogen may be combusted or directed to other beneficial uses and any carbon dioxide or carbon monoxide may be redirected to carrier gas 15. Conventional techniques and/or the techniques described in these references may be used to recover nitrogen, oxygen, carbon monoxide, and/or carbon dioxide from the tail gas and recycle at least a portion of the recovered gas to carrier gas 15. At least a portion of the trace nitrogen and sulfur species mentioned above may be recycled to carrier gas 15 without further processing if desired. For example, the tail gas may be combusted and at least a portion of the resulting gases redirected for use as carrier gas 15. In certain embodiments, water can be condensed and removed from the combusted tailgas, thus reducing the amount of hydrogen atoms directed to plasma zone 10. Alternatively, hydrogen may be removed from the tail gas using any conventional means. Heat recovered during processing of the tail gas may be used to heat various fluid flows in the various embodiments herein, for example, to preheat carrier gas 15, feedstock 30, or oxygen-containing species separately introduced to reactor zone 20. Alternatively or in addition, heat from the combustion of the tail gas or the hydrogen in the tail gas may be used to generate electricity for use with the embodiments herein, for example, to preheat the feedstock or any of the gases directed into plasma carbon black reactor 5.

In certain embodiments, an aqueous slurry of limestone, lime, or other alkaline sorbent known to those of skill in the art may be combined with the combusted tail gas. Preferable slurries comprise limestone, lime, or both. The formation of gypsum through contact of the slurry with the combusted tail gas removes sulfur from the gas, while the use of a wet slurry condenses moisture in the combusted tail gas, resulting in a cleaned, dewatered flue gas with 85-95% less moisture than the combusted tail gas. The flue gas contains primarily nitrogen, carbon dioxide, and a small amount of water and can be recycled for use in carrier gas 15, processed for carbon capture, or discharged. Following filtering and drying of the gypsum, the resulting water may be recycled for beneficial use in the carbon black production process, for example, as the make water for the slurry or as quench water, for example, quench spray 35. For continuous dewatering and scrubbing of the combusted tail gas, it is preferable to remove heat from the combusted tail gas, for example, via a heat exchanger, to promote condensation in the presence of the slurry.

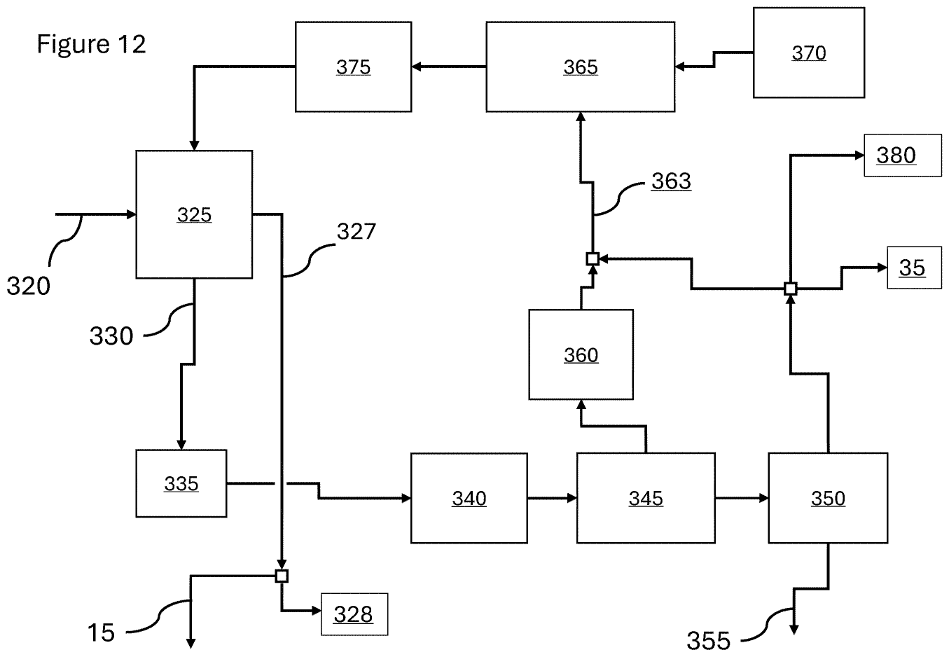

An exemplary schematic is shown in FIG. 12. Combusted tail gas 320 contains SOₓ and significant moisture, e.g., 35-45% by volume. In combined dewatering and scrubbing unit 325, combusted tail gas 320 is combined with an aqueous slurry of alkaline sorbent such as limestone. One output of combined dewatering and scrubbing unit 325 is a cleaned, dewatered flue gas 327 with 2-6 vol % water. Dewatered flue gas 327 may be recycled for use as carrier gas 15, or at least a portion may be directed to carbon capture 328 or discharged. A second output of combined dewatering and scrubbing unit 325 is a dilute gypsum 330 that is passed to a slurry receiver 335 and then via slurry pump 340 to filter 345. The filtered gypsum is processed in wash and dewater unit 350, from which dewatered gypsum 355 may be recovered. Water leaving filter 345 is passed through cooler 360, which may be any suitable cooler, e.g., a fin-fan cooler. Likewise, water from wash and dewater unit 350 may be directed to the carbon black reactor, e.g., plasma carbon black reactor 5, for use as quench water, e.g., quench water 35. Alternatively or in addition, it may be combined with the water leaving filter 345 to form a recycled water stream 363 for use in limestone slurry tank 365. In slurry tank 365, water is combined with crushed limestone 370 and the resulting slurry directed by slurry pump 375 to scrubbing unit 325. Excess water may be directed to wastewater treatment 380.

The resulting carbon black may be surface treated, pelletized, or otherwise processed in any manner utilized for other carbon blacks. As an option, the carbon black provided herein can have functional groups or chemical groups (e.g., derived from small molecules or polymers, either ionic or nonionic) that are directly attached to the carbon surface (e.g., covalently attached). Examples of functional groups that can be directly attached (e.g., covalently) to the surface of the carbon black particles and methods for carrying out the surface modification are described, for example, in U.S. Pat. No. 5,554,739 issued to Belmont on Sep. 10, 1996 and U.S. Pat. No. 5,922,118 to Johnson et al. on Jul. 13, 1999, incorporated herein by reference in their entirety. As one illustration, a surface modified carbon black that can be employed here is obtained by treating carbon black with diazonium salts formed by the reaction of either sulfanilic acid or para-amino-benzoic acid (PABA) with HCl and NaNO₂. Surface modification by sulfanilic or para-amino-benzoic acid processes using diazonium salts, for example, results in carbon black having effective amounts of hydrophilic moieties on the carbon coating.

Alternatively or in addition the carbon black can be surface modified according to any of U.S. Pat. Nos. 8,975,316 and 10,640,630 to Belmont et al., the contents of which are incorporated herein by reference in their entirety. Other techniques that can be used to provide functional groups attached to the surface of the carbon black are described in U.S. Pat. No. 7,300,964, issued to Niedermeier et al, on Nov. 27, 2007, the contents of which are incorporated by reference herein in their entirety.

Oxidized (modified) carbon black can be prepared in a manner similar to that used on carbon black, as described, for example, in U.S. Pat. No. 7,922,805 issued to Kowalski et al. on Apr. 12, 2011, and in U.S. Pat. No. 6,471,763 issued to Karl on Oct. 29, 2002, both of which are incorporated herein by reference in their entirety. An oxidized carbon black is one that that has been oxidized using an oxidizing agent in order to introduce ionic and/or ionizable groups onto the surface. Such particles may have a higher degree of oxygen-containing groups on the surface. Oxidizing agents include, but are not limited to, oxygen gas, ozone, peroxides such as hydrogen peroxide, persulfates, including sodium and potassium persulfate, hypohalites such a sodium hypochlorite, oxidizing acids such as nitric acid, and transition metal containing oxidants, such as permanganate salts, osmium tetroxide, chromium oxides, or ceric ammonium nitrate. Mixtures of oxidants may also be used, particularly mixtures of gaseous oxidants such as oxygen and ozone. Other surface modification methods, such as chlorination and sulfonylation, may also be employed to introduce ionic or ionizable groups.

Alternatively or in addition, the carbon black can be etched to modify its porosity or microstructure as described in U.S. Pat. No. 10,087,330 to Green, et al., the entire contents of which are incorporated herein by reference.

Alternatively or in addition, the carbon black may be coated with additional carbon as described in U.S. Pat. No. 10,519,298, the entire contents of which are incorporated herein by reference. For example, the smoke stream may be directly charged into a carbon black furnace reactor for further coating with carbon resulting from a furnace process, or the carbon black may be separated from the tail gas and then directed into a furnace reactor.

The carbon black can be utilized in various applications, such as, for example, as reinforcement in rubber products, e.g., tire components.

The carbon black can be incorporated in rubber articles, being used, for instance, for tire tread, especially in tread for passenger car, light vehicle, truck and bus tires, off-the-road (“OTR”) tires, airplane tires and the like; sub-tread; wire skim; sidewalls; cushion gum for retread tires; and other tire uses.

In other applications, the particles can be used in industrial rubber articles, such as engine mounts, hydro-mounts, bridge bearings and seismic isolators, tank tracks or tread, mining belts, hoses, gaskets, seals, blades, weather stripping articles, bumpers, anti-vibration parts, and others.

The carbon black can be added as an alternative or in addition to first reinforcing agents for tire components and/or other industrial rubber end-uses. The carbon black can be combined with natural and/or synthetic rubber in a suitable dry or wet mixing process based on an internal batch mixer, continuous mixer or roll mill.

The present invention includes the following aspects/embodiments/features in any order and/or in any combination:
1. The present invention, in part, relates to a method of making carbon black, said method comprising:
   generating a plasma in a gas stream to create a hot carrier gas stream; and
combining a feedstock comprising a liquid feedstock with the hot carrier gas stream to form a mixture, wherein the mixture of the feedstock and the hot carrier gas has an atomic ratio H:C of at most 3:1, to produce a carbon black,
   wherein a net energy to manufacture 1 kg of carbon black is no greater than 6 kWh, a gas traffic is no greater than 1 kmol/kg carbon black, or both.
2. The method of any preceding or following embodiment/feature/aspect, further comprising, before combining, introducing the hot carrier gas stream to a reaction zone of a plasma carbon black reactor, the reaction zone having a substantially cylindrical wall, the hot carrier gas stream being introduced at an angle that is within 10 degrees of a tangent to the wall, for example, within 5 degrees, within 2 degrees, or within 1 degree.
3. The method of any preceding or following embodiment/feature/aspect, wherein introducing is performed at an angle that is from 45 degrees to 90 degrees with respect to a longitudinal axis of the reactor.
4. The method of any preceding or following embodiment/feature/aspect, wherein A) a surface area of the carbon black satisfies I2No≥142 (gas traffic)−22, where iodine number is in mg/g and gas traffic is in kmol/kg carbon black, B) wherein a net energy input Q in kWh to manufacture 1 kg of carbon black satisfies I2No≥21Q−124, or both.
5. The method of any preceding or following embodiment/feature/aspect, further comprising, before combining, introducing the hot carrier gas stream to a circularly cross-sectioned region of a plasma carbon black reactor, the hot carrier gas stream being introduced along a longitudinal axis of the circularly cross-sectioned region.
6. The method of any preceding or following embodiment/feature/aspect, wherein a diameter of the circularly cross-sectioned region is not constant.
7. The method of any preceding or following embodiment/feature/aspect, wherein A) a net energy input Q is no greater than 6 kWh/kg carbon black for I2No being less than 100 mg/g and satisfies the equation I2No≥7Q+58 for I2No of 100 mg/g or greater, wherein I2No is in mg/g and Q is in kWh/kg carbon black, B) a surface area of the carbon black satisfies I2No≥188 (gas traffic)−8, where gas traffic is in kmol/kg carbon black, or both.
8. The method of any preceding or following embodiment/feature/aspect, further comprising allowing the hot carrier gas stream to pass through a throat region of a plasma carbon black reactor to a reaction zone of the plasma carbon black reactor, wherein combining comprises introducing the feedstock to the hot carrier gas stream in one or both of the throat region and the reaction zone, and wherein an interior diameter of the reaction zone is greater than an interior diameter of the throat region.
9. The method of any preceding or following embodiment/feature/aspect, wherein generating is performed in a plasma zone of a plasma carbon black reactor, the plasma zone having an interior diameter, and wherein the mixture of the hot carrier gas stream and the feedstock passes through a reaction zone in fluidic communication with the plasma zone and having an interior diameter greater than that of the plasma zone.
10. The method of any preceding or following embodiment/feature/aspect, wherein the atomic ratio O:C in the mixture of the feedstock and the hot carrier gas is from 0.05 to 2, for example, from 0.07 to 0.09, from 0.09 to 0.13, from 0.13 to 0.17, from 0.17 to 0.2, from 0.2 to 0.23, from 0.23 to 0.27, from 0.27 to 0.3, from 0.3 to 0.35, from 0.35 to 0.4, from 0.4 to 0.6, from 0.6 to 0.8, from 0.8 to 1, from 1 to 1.2, from 1.2 to 1.4, from 1.4 to 1.6, from 1.6 to 1.8, or from 1.8 to 2.
11. The method of any preceding or following embodiment/feature/aspect, wherein the gas stream is heated prior to generating.
12. The method of any preceding or following embodiment/feature/aspect, wherein generating is performed with at least one plasma torch.
13. The method of any preceding or following embodiment/feature/aspect, wherein the at least one plasma torch is part of a transferred arc system.
14. The method of any preceding or following embodiment/feature/aspect, wherein an anode of the transferred arc system comprises a compressed bed of carbonaceous material.
15. The method of any preceding or following embodiment/feature/aspect, wherein an anode of the transferred arc system comprises silicon, iron, aluminosilicates, magnesium oxide, yttria-stabilized zirconia, or molten salts.
16. The method of any preceding or following embodiment/feature/aspect, wherein generating occurs in a plasma zone of a plasma carbon black reactor, and wherein the method further comprises feeding electrode material into the plasma zone from an exterior of the plasma carbon black reactor.
17. The method of any preceding or following embodiment/feature/aspect, wherein feeding takes place simultaneously with generating or feeding is alternated with generating at predetermined intervals.
18. The method of any preceding or following embodiment/feature/aspect, further comprising using a gas flow to cool the at least one plasma torch, wherein the gas flow becomes part of the hot carrier gas stream.
19. The method of any preceding or following embodiment/feature/aspect, wherein combining comprises introducing the feedstock into at least two locations of a plasma carbon black reactor, wherein the second location is downstream of the first location.
20. The method of any preceding or following embodiment/feature/aspect, further comprising introducing particles into one or more of the gas stream, the hot carrier gas stream, or the mixture.
21. The method of any preceding or following embodiment/feature/aspect, wherein the plasma is formed in a plasma zone of a plasma carbon black reactor, and wherein the particles are introduced in the plasma zone.
22. The method of any preceding or following embodiment/feature/aspect, wherein the combining is performed in a reaction zone of a plasma carbon black reactor, and the particles are introduced in the reaction zone in a flow stream separate from the feedstock.
23. The method of any preceding or following embodiment/feature/aspect, wherein generating is performed in a plasma zone of a plasma carbon black reactor, wherein combining is performed in a throat region in fluidic communication with the throat region, wherein the plasma carbon black reactor further comprises a reaction zone into which the mixture travels from the throat region, wherein the particles are introduced in the reaction zone in a flow stream separate from the feedstock.
24. The method of any preceding or following embodiment/feature/aspect, wherein the atomic ratio H:C in the mixture of the feedstock and the hot carrier gas stream is no greater than 2.5:1 or no greater than 2:1.
25. The present invention further relates to a method of making carbon black, comprising:
   generating a plasma in a gas stream to create a hot carrier gas stream; and
   combining a feedstock with the hot carrier gas stream, wherein the mixture of the feedstock and the hot carrier gas has an atomic ratio O:C of from 0.05 to 2 and an atomic ratio H:C of at most 3:1, to produce carbon black.
26. The method of any preceding or following embodiment/feature/aspect, wherein the atomic ratio O:C is from 0.07 to 0.09, from 0.09 to 0.13, from 0.13 to 0.17, from 0.17 to 0.2, from 0.2 to 0.23, from 0.23 to 0.27, from 0.27 to 0.3, from 0.3 to 0.35, from 0.35 to 0.4, from 0.4 to 0.6, from 0.6 to 0.8, from 0.8 to 1, from 1 to 1.2, from 1.2 to 1.4, from 1.4 to 1.6, from 1.6 to 1.8, or from 1.8 to 2.
27. The method of any preceding or following embodiment/feature/aspect, further comprising, before combining, introducing the hot carrier gas stream to a reaction zone of a plasma carbon black reactor, the reaction zone having a substantially cylindrical wall, the hot carrier gas stream being introduced at an angle that is within 10 degrees of a tangent to the wall, for example, within 5 degrees, within 2 degrees, or within 1 degree.
28. The method of any preceding or following embodiment/feature/aspect, wherein introducing is performed at an angle that is from 45 degrees to 90 degrees with respect to a longitudinal axis of the reaction zone.
29. The method of any preceding or following embodiment/feature/aspect, wherein A) a surface area of the carbon black satisfies I2No≥142 (gas traffic)−22, where iodine number is in mg/g and gas traffic is in kmol/kg carbon black, B) wherein a net energy input Q in kWh to manufacture 1 kg of carbon black satisfies 12No≥21Q−124, or both.
30. The method of any preceding or following embodiment/feature/aspect, further comprising, before combining, introducing the hot carrier gas stream to a circularly cross-sectioned region of a plasma carbon black reactor, the hot carrier gas stream being introduced along a longitudinal axis of the circularly cross-sectioned region.
31. The method of any preceding or following embodiment/feature/aspect, wherein a diameter of the circularly cross-sectioned region is not constant.
32. The method of any preceding or following embodiment/feature/aspect, wherein A) a net energy input Q is no greater than 6 kWh/kg carbon black for I2No being less than 100 mg/g and satisfies the equation I2No≥7Q+58 for I2No of 100 mg/g or greater, wherein I2No is in mg/g and Q is in kWh/kg carbon black, B) a surface area of the carbon black satisfies I2No≥188 (gas traffic)−8, where gas traffic is in kmol/kg carbon black, or both.
33. The method of any preceding or following embodiment/feature/aspect, wherein the atomic ratio H:C in the mixture of the feedstock and the hot carrier gas stream is no greater than 2.5:1 or no greater than 2:1.
34. The method of any preceding or following embodiment/feature/aspect, wherein the gas stream is heated prior to generating.
35. The method of any preceding or following embodiment/feature/aspect, wherein generating is performed with at least one plasma torch.
36. The method of any preceding or following embodiment/feature/aspect, wherein the at least one plasma torch is part of a transferred arc system.
37. The method of any preceding or following embodiment/feature/aspect, wherein an anode of the transferred arc system comprises a compressed bed of carbonaceous material.
38. The method of any preceding or following embodiment/feature/aspect, wherein an anode of the transferred arc system comprises silicon, iron, aluminosilicates, magnesium oxide, yttria-stabilized zirconia, or molten salts.
39. The method of any preceding or following embodiment/feature/aspect, wherein generating occurs in a plasma zone of a plasma carbon black reactor, and wherein the method further comprises feeding electrode material into the plasma zone from an exterior of the plasma carbon black reactor.
40. The method of any preceding or following embodiment/feature/aspect, wherein feeding takes place simultaneously with generating or feeding is alternated with generating at predetermined intervals.
41. The method of any preceding or following embodiment/feature/aspect, further comprising using a gas flow to cool the at least one plasma torch, wherein the gas flow becomes part of the hot carrier gas stream.
42. The method of any preceding or following embodiment/feature/aspect, combining comprises introducing the feedstock into at least two locations of a plasma carbon black reactor, wherein the second location is downstream of the first location.
43. The method of any preceding or following embodiment/feature/aspect, further comprising introducing particles into one or more of the gas stream, the hot carrier gas stream, or the mixture.
44. The method of any preceding or following embodiment/feature/aspect, wherein the plasma is generated in a plasma zone of a plasma carbon black reactor, and wherein the particles are introduced in the plasma zone.
45. The method of any preceding or following embodiment/feature/aspect, wherein the combining is performed in a reaction zone of a plasma carbon black reactor, and the particles are introduced in the reaction zone in a flow stream separate from the feedstock.
46. The method of any preceding or following embodiment/feature/aspect, wherein generating is performed in a plasma zone of a plasma carbon black reactor, wherein combining is performed in a throat region in fluidic communication with the throat region, wherein the plasma carbon black reactor further comprises a reaction zone into which the mixture travels from the throat region, wherein the particles are introduced in the reaction zone in a flow stream separate from the feedstock.
47. The method of any preceding or following embodiment/feature/aspect, further comprising allowing the hot carrier gas stream to pass through a throat region of a plasma carbon black reactor to a reaction zone of the plasma carbon black reactor, wherein combining comprises introducing the feedstock to the hot carrier gas stream in one or both of the throat region and the reaction zone, and wherein an interior diameter of the reaction zone is greater than an interior diameter of the throat region.
48. The method of any preceding or following embodiment/feature/aspect, wherein generating is performed in a plasma zone of a plasma carbon black reactor, the plasma zone having an interior diameter, and wherein the mixture of the hot carrier gas stream and the feedstock passes through a reaction zone having an interior diameter greater than that of the plasma zone.
49. The method of any preceding or following embodiment/feature/aspect, wherein the gas traffic is no greater than 1 kmol/kg carbon black.
50. The method of any preceding or following embodiment/feature/aspect, wherein the net energy input per kg carbon black is no greater than 9 kWh, for example, no greater than 6 kWh.
51. The present invention further relates to a method of making carbon black, comprising:
   generating a plasma in a gas stream to create a hot carrier gas stream;
   introducing the hot carrier gas stream to a circularly cross-sectioned region of a plasma carbon black reactor, the hot carrier gas stream being introduced along a longitudinal axis of the circularly cross-sectioned region; and
   combining a feedstock comprising a liquid feedstock with the hot carrier gas stream to form carbon black, wherein the mixture of the feedstock and the hot carrier gas has an atomic ratio H:C of at most 3:1, wherein a net energy input Q is no greater than 6 kWh/kg carbon black for I2No being less than 100 mg/g and satisfies the equation I2No≥7Q+58 for I2No of 100 mg/g or greater, wherein I2No is in mg/g and Q is in kWh/kg carbon black, and wherein a gas traffic during the reaction is no greater than 1 kmol/kg carbon black.
52. The method of any preceding or following embodiment/feature/aspect, wherein a diameter of the circularly cross-sectioned region is not constant.
53. The method of any preceding or following embodiment/feature/aspect, wherein the circularly cross-sectioned region comprises a throat region and a reaction zone, the method further comprising allowing the hot carrier gas stream to pass through a throat region of the plasma carbon black reactor to the reaction zone, wherein combining comprises introducing the feedstock to the hot carrier gas stream in one or both of the throat region and the reaction zone, and wherein an interior diameter of the reaction zone is greater than an interior diameter of the throat region.
54. The method of any preceding or following embodiment/feature/aspect, wherein generating is performed in a plasma zone of the plasma carbon black reactor, the plasma zone having an interior diameter and being in fluidic communication with the circularly cross-sectioned region, the circularly cross-sectioned region comprising a reaction zone, and wherein the mixture of the hot carrier gas stream and the feedstock passes through the reaction zone, and wherein the reaction zone has an interior diameter greater than that of the plasma zone, and wherein introducing is performed in the reaction zone, upstream of the reaction zone, or both.
55. The method of any preceding or following embodiment/feature/aspect, wherein the gas traffic satisfies I2No≥188 (gas traffic)−8, where iodine number is in mg/g, and gas traffic is in kmol/kg carbon black.
56. The method of any preceding or following embodiment/feature/aspect, wherein the net energy input per kg carbon black is no greater than 9 kWh for carbon black having an iodine number of 100 mg/g or greater.
57. The method of any preceding or following embodiment/feature/aspect, wherein wherein an atomic ratio O:C in the mixture of the feedstock and the hot carrier gas is from 0.05 to 2, for example, from 0.07 to 0.09, from 0.09 to 0.13, from 0.13 to 0.17, from 0.17 to 0.2, from 0.2 to 0.23, from 0.23 to 0.27, from 0.27 to 0.3, from 0.3 to 0.35, from 0.35 to 0.4, from 0.4 to 0.6, from 0.6 to 0.8, from 0.8 to 1, from 1 to 1.2, from 1.2 to 1.4, from 1.4 to 1.6, from 1.6 to 1.8, or from 1.8 to 2.
58. The method of any preceding or following embodiment/feature/aspect, wherein the gas stream is heated prior to generating.
59. The method of any preceding or following embodiment/feature/aspect, wherein generating is performed with at least one plasma torch.
60. The method of any preceding or following embodiment/feature/aspect, wherein the at least one plasma torch is part of a transferred arc system.
61. The method of any preceding or following embodiment/feature/aspect, wherein an anode of the transferred arc system comprises a compressed bed of carbonaceous material.
62. The method of any preceding or following embodiment/feature/aspect, wherein an anode of the transferred arc system comprises silicon, iron, aluminosilicates, magnesium oxide, yttria-stabilized zirconia, or molten salts.
63. The method of any preceding or following embodiment/feature/aspect, wherein generating occurs in a plasma zone in fluidic communication with the circularly cross-sectioned region, and wherein the method further comprises feeding electrode material into the plasma zone from an exterior of the plasma carbon black reactor.
64. The method of any preceding or following embodiment/feature/aspect, wherein feeding takes place simultaneously with generating or feeding is alternated with generating at predetermined intervals.
65. The method of any preceding or following embodiment/feature/aspect, further comprising using a gas flow to cool the at least one plasma torch, wherein the gas flow becomes part of the hot carrier gas stream.
66. The method of any preceding or following embodiment/feature/aspect, combining comprises introducing the feedstock into the plasma carbon black reactor in at least two locations, wherein the second location is downstream of the first location.
67. The method of any preceding or following embodiment/feature/aspect, further comprising introducing particles into the plasma carbon black reactor.
68. The method of any preceding or following embodiment/feature/aspect, wherein the plasma is formed in a plasma zone in fluidic communication with the circularly cross-sectioned region, and wherein the particles are introduced in the plasma zone.
69. The method of any preceding or following embodiment/feature/aspect, wherein the circularly cross-sectioned region comprises a reaction zone, wherein the combining is performed in the reaction zone, and the particles are introduced in the reaction zone in a flow stream separate from the feedstock.
70. The method of any preceding or following embodiment/feature/aspect, wherein the circularly cross-sectioned region comprises a reaction zone and a throat region, wherein the combining is performed in the throat region, and the particles are introduced in the reaction zone in a flow stream separate from the feedstock.
71. The method of any preceding or following embodiment/feature/aspect, wherein the atomic ratio H:C in the mixture of the feedstock and the hot carrier gas stream is no greater than 2.5:1 or no greater than 2:1.
72. The present invention further relates to a method of making carbon black, comprising:
   generating a plasma in a carrier gas stream to create a hot carrier gas stream;
   introducing the hot carrier gas stream to a reaction zone of a plasma carbon black reactor, the reaction zone having a substantially cylindrical wall, the hot carrier gas stream being introduced at an angle to the wall that is within 10 degrees of a tangent to the wall; and
   combining a feedstock with the hot carrier gas stream to produce carbon black.
73. The method of any preceding or following embodiment/feature/aspect, wherein introducing is performed at an angle that is from 45 degrees to 90 degrees with respect to a longitudinal axis of the reaction zone.
74. The method of any preceding or following embodiment/feature/aspect, wherein the hot carrier gas stream is introduced at an angle to the wall that is within 5 degrees, for example, within 2 degrees or within 1 degree, of a tangent to the wall.
75. The method of any preceding or following embodiment/feature/aspect, wherein a surface area of the carbon black satisfies I2No≥142 (gas traffic)−22, where iodine number is in mg/g and gas traffic is in kmol/kg carbon black.
76. The method of any preceding or following embodiment/feature/aspect, wherein the gas traffic is no greater than 1 kmol/kg carbon black.
77. The method of any preceding or following embodiment/feature/aspect, wherein a net energy input Q in kWh to manufacture 1 kg of carbon black satisfies I2No≥21Q−124, where iodine number is in mg/g.
78. The method of any preceding or following embodiment/feature/aspect, wherein the net energy input per kg carbon black is no greater than 9 kWh, for example, no greater than 6 kWh.
79. The method of any preceding or following embodiment/feature/aspect, wherein the atomic ratio H:C in the mixture of the feedstock and the hot carrier gas stream is no greater than 3:1, for example, no greater than 2.5:1 or no greater than 2:1.
80. The method of any preceding or following embodiment/feature/aspect, wherein an atomic O:C ratio of the mixture of feedstock and hot carrier gas ranges from 0.05 to 2, for example, from 0.07 to 0.09, from 0.09 to 0.13, from 0.13 to 0.17, from 0.17 to 0.2, from 0.2 to 0.23, from 0.23 to 0.27, from 0.27 to 0.3, from 0.3 to 0.35, from 0.35 to 0.4, from 0.4 to 0.6, from 0.6 to 0.8, from 0.8 to 1, from 1 to 1.2, from 1.2 to 1.4, from 1.4 to 1.6, from 1.6 to 1.8, or from 1.8 to 2.
81. The method of any preceding or following embodiment/feature/aspect, wherein the gas stream is heated prior to generating.
82. The method of any preceding or following embodiment/feature/aspect, wherein generating is performed with at least one plasma torch.
83. The method of any preceding or following embodiment/feature/aspect, wherein the at least one plasma torch is part of a transferred arc system.
84. The method of any preceding or following embodiment/feature/aspect, wherein an anode of the transferred arc system comprises a compressed bed of carbonaceous material.
85. The method of any preceding or following embodiment/feature/aspect, wherein an anode of the transferred arc system comprises silicon, iron, aluminosilicates, magnesium oxide, yttria-stabilized zirconia, or molten salts.
86. The method of any preceding or following embodiment/feature/aspect, wherein generating occurs in a plasma zone in fluidic communication with the reaction zone, and wherein the method further comprises feeding electrode material into the plasma zone from an exterior of the plasma carbon black reactor.
87. The method of any preceding or following embodiment/feature/aspect, wherein feeding takes place simultaneously with generating or feeding is alternated with generating at predetermined intervals.
88. The method of any preceding or following embodiment/feature/aspect, further comprising using a gas flow to cool the at least one plasma torch, wherein the gas flow becomes part of the hot carrier gas stream.
89. The method of any preceding or following embodiment/feature/aspect, combining comprises introducing the feedstock into the plasma carbon black reactor in at least two locations, wherein the second location is downstream of the first location.
90. The method of any preceding or following embodiment/feature/aspect, further comprising introducing particles into the plasma carbon black reactor.
91. The method of any preceding or following embodiment/feature/aspect, wherein the plasma is formed in a plasma zone in fluidic communication with the reaction zone, and wherein the particles are introduced in the plasma zone.
92. The method of any preceding or following embodiment/feature/aspect, wherein the combining is performed in the reaction zone, and the particles are introduced in the reaction zone in a flow stream separate from the feedstock.
93. The present invention further relates to a method of making carbon black, comprising:
   generating a plasma in a gas stream to create a hot carrier gas stream;
   introducing the hot carrier gas stream to a circularly cross-sectioned region of a plasma carbon black reactor, the hot carrier gas stream being introduced along a longitudinal axis of the circularly cross-sectioned region; and
   combining a feedstock comprising a liquid feedstock with the hot carrier gas stream, wherein the mixture of the feedstock and the hot carrier gas has an atomic ratio H:C of at most 3:1, to produce a carbon black,
   wherein a surface area of the carbon black satisfies I2No≥188 (gas traffic)−8, where iodine number is in mg/g, gas traffic is in kmol/kg carbon black, and wherein gas traffic is no greater than 1 kmol/kg carbon black.
94. The method of any preceding or following embodiment/feature/aspect, wherein a diameter of the circularly cross-sectioned region is not constant.
95. The method of any preceding or following embodiment/feature/aspect, wherein the circularly cross-sectioned region comprises a throat region and a reaction zone, wherein introducing comprises allowing the hot carrier gas stream to pass through a throat region of the plasma carbon black reactor to the reaction zone, wherein combining comprises introducing the feedstock to the hot carrier gas stream in one or both of the throat region and the reaction zone, and wherein an interior diameter of the reaction zone is greater than an interior diameter of the throat region.
96. The method of any preceding or following embodiment/feature/aspect, wherein generating is performed in a plasma zone of the plasma carbon black reactor, the plasma zone having an interior diameter and being in fluidic communication with the circularly cross-sectioned region, the circularly cross-sectioned region comprising a reaction zone, and wherein the mixture of the hot carrier gas stream and the feedstock passes through the reaction zone, and wherein the reaction zone has an interior diameter greater than that of the plasma zone, and wherein introducing is performed in the reaction zone, upstream of the reaction zone, or both.
97. The method of any preceding or following embodiment/feature/aspect, wherein a net energy input Q is no greater than 6 kWh/kg carbon black for I2No being less than 100 mg/g and satisfies the equation I2No≥7Q+58 for I2No of 100 mg/g or greater, wherein I2No is in mg/g and Q is in kWh/kg carbon black.
98. The method of any preceding or following embodiment/feature/aspect, wherein a net energy input per kg carbon black is no greater than 9 kWh for carbon black having an iodine number of 100 mg/g or greater, for example, no greater than 6 kWh.
99. The method of any preceding or following embodiment/feature/aspect, wherein an atomic O:C ratio of the mixture of feedstock and hot carrier gas ranges from 0.05 to 2, for example, from 0.07 to 0.09, from 0.09 to 0.13, from 0.13 to 0.17, from 0.17 to 0.2, from 0.2 to 0.23, from 0.23 to 0.27, from 0.27 to 0.3, from 0.3 to 0.35, from 0.35 to 0.4, from 0.4 to 0.6, from 0.6 to 0.8, from 0.8 to 1, from 1 to 1.2, from 1.2 to 1.4, from 1.4 to 1.6, from 1.6 to 1.8, or from 1.8 to 2.
100. The method of any preceding or following embodiment/feature/aspect, wherein the gas stream is heated prior to generating.
101. The method of any preceding or following embodiment/feature/aspect, wherein generating is performed with at least one plasma torch.
102. The method of any preceding or following embodiment/feature/aspect, wherein the at least one plasma torch is part of a transferred arc system.
103. The method of any preceding or following embodiment/feature/aspect, wherein an anode of the transferred arc system comprises a compressed bed of carbonaceous material.
104. The method of any preceding or following embodiment/feature/aspect, wherein an anode of the transferred arc system comprises silicon, iron, aluminosilicates, magnesium oxide, yttria-stabilized zirconia, or molten salts.
105. The method of any preceding or following embodiment/feature/aspect, wherein generating occurs in a plasma zone in fluidic communication with the circularly cross-sectioned region, and wherein the method further comprises feeding electrode material into the plasma zone from an exterior of the plasma carbon black reactor.
106. The method of any preceding or following embodiment/feature/aspect, wherein feeding takes place simultaneously with generating or feeding is alternated with generating at predetermined intervals.
107. The method of any preceding or following embodiment/feature/aspect, further comprising using a gas flow to cool the one or more plasma torches, wherein the gas flow becomes part of the hot carrier gas stream.
108. The method of any preceding or following embodiment/feature/aspect, combining comprises introducing the feedstock into the plasma carbon black reactor in at least two locations, wherein the second location is downstream of the first location.
109. The method of any preceding or following embodiment/feature/aspect, further comprising introducing particles into the plasma carbon black reactor.
110. The method of any preceding or following embodiment/feature/aspect, wherein the plasma is formed in a plasma zone in fluidic communication with the circularly cross-sectioned region, and wherein the particles are introduced in the plasma zone.
111. The method of any preceding or following embodiment/feature/aspect, wherein the circularly cross-sectioned region comprises a reaction zone, wherein the combining is performed in the reaction zone, and the particles are introduced in the reaction zone in a flow stream separate from the feedstock.
112. The method of any preceding or following embodiment/feature/aspect, wherein the circularly cross-sectioned region comprises a reaction zone and a throat region, wherein the combining is performed in the throat region, and the particles are introduced in the reaction zone in a flow stream separate from the feedstock.
113. The method of any preceding or following embodiment/feature/aspect, wherein the atomic ratio H:C in the mixture of the feedstock and the hot carrier gas stream is no greater than 2.5:1, for example, no greater than 2:1.
114. The present invention further relates to a method of making carbon black, comprising:
   generating a first plasma in a first gas stream in a first plasma zone of a plasma carbon black reactor to create a first hot carrier gas stream;
   generating a second plasma in a second gas stream in a second plasma zone of the plasma carbon black reactor to create a second hot carrier gas stream;
   directing the first and second hot carrier gas streams towards each other along first and second axes such that the first and second hot carrier gas streams combine at a location in a reaction zone having a third axis, wherein the first and second axes are at an angle from 30 to 90 deg to an upstream end of the reaction zone; and
   directing a feedstock towards the location, to one more cross-sections of the reaction zone downstream of the location, or both, to mix the feedstock with the combined first and second hot carrier gas streams to produce carbon black, the carbon black leaving the reaction zone at a downstream end.
115. The method of any preceding or following embodiment/feature/aspect, wherein the first and second axes are perpendicular to the third axis.
116. The method of any preceding or following embodiment/feature/aspect, wherein the gas traffic is no greater than 1 kmol/kg carbon black.
117. The method of any preceding or following embodiment/feature/aspect, wherein the net energy input per kg carbon black is no greater than 9 kWh, for example, no greater than 6 kWh.
118. The method of any preceding or following embodiment/feature/aspect, wherein the energy input per kg carbon black is no greater than 6 kWh for carbon black having an iodine number less than 100 mg/g and no greater than 9 kWh for carbon black having an iodine number of 100 mg/g or greater.
119. The method of any preceding or following embodiment/feature/aspect, wherein an atomic O:C ratio of the mixture of feedstock and hot carrier gas ranges from 0.05 to 2, for example, from 0.07 to 0.09, from 0.09 to 0.13, from 0.13 to 0.17, from 0.17 to 0.2, from 0.2 to 0.23, from 0.23 to 0.27, from 0.27 to 0.3, from 0.3 to 0.35, from 0.35 to 0.4, from 0.4 to 0.6, from 0.6 to 0.8, from 0.8 to 1, from 1 to 1.2, from 1.2 to 1.4, from 1.4 to 1.6, from 1.6 to 1.8, or from 1.8 to 2.
120. The method of any preceding or following embodiment/feature/aspect, wherein generating a first plasma and generating a second plasma are each independently performed with at least one plasma torch.
121. The method of any preceding or following embodiment/feature/aspect, wherein the at least one plasma torch for the first plasma, the at least one plasma torch for the second plasma, or both, is part of a transferred arc system.
122. The method of any preceding or following embodiment/feature/aspect, wherein an anode of the transferred arc comprises a compressed bed of carbonaceous material.
123. The method of any preceding or following embodiment/feature/aspect, wherein an anode of the transferred arc comprises silicon, iron, aluminosilicates, magnesium oxide, yttria-stabilized zirconia, or molten salts.
124. The method of any preceding or following embodiment/feature/aspect, wherein the method further comprises feeding electrode material into at least one of the first and second plasma zones from an exterior of the plasma carbon black reactor.
125. The method of any preceding or following embodiment/feature/aspect, wherein feeding takes place simultaneously with generating or feeding is alternated with generating at predetermined intervals.
126. The method of any preceding or following embodiment/feature/aspect, further comprising using a gas flow to cool the one or more plasma torches, wherein the gas flow becomes part of the hot carrier gas stream.
127. The method of any preceding or following embodiment/feature/aspect, further comprising introducing particles into the plasma carbon black reactor.
128. The method of any preceding or following embodiment/feature/aspect, wherein the particles are introduced in the first plasma zone, the second plasma zone, or both.
129. The method of any preceding or following embodiment/feature/aspect, wherein particles are introduced in the reaction zone in a flow stream separate from the feedstock.
130. The method of any preceding or following embodiment/feature/aspect, wherein the plasma carbon black reactor further comprises first and second throat regions interposed between the first and second plasma zones, respectively, and the reaction zone, wherein the feedstock is directed from the throat region and the particles are introduced in the reaction zone.
131. The method of any preceding or following embodiment/feature/aspect, wherein the atomic ratio H:C in the mixture of the feedstock and the hot carrier gas stream is no greater than 3:1, for example, no greater than 2.5:1 or no greater than 2:1.
132. The method of any preceding or following embodiment/feature/aspect, wherein the gas stream is heated prior to generating.
133. The method of any preceding or following embodiment/feature/aspect, wherein the mixture of the feedstock and the hot carrier gas has an atomic ratio H:C of at most 2:1, at most 1.5:1, at most 1.3:1, at most 1:1, at most 1.5:2, at most 1.3:2, from 1:2 to 3:1, from 1.5:2 to 2.5:1, or from 1.3:2 to 2:1.
134. The method of any preceding or following embodiment/feature/aspect, wherein the gas stream has at most 5 vol % hydrogen.
135. The method of any preceding or following embodiment/feature/aspect, wherein the gas stream comprises one or more of nitrogen, argon, carbon dioxide, water vapor, or carbon monoxide.
136. The method of any preceding or following embodiment/feature/aspect, further comprising quenching the production of carbon black to form a smoke stream comprising particulate carbon and gases; wherein a mass ratio of solid carbon that builds up in the carbon black reactor over a period of 8 hours with respect to the particulate carbon that leaves the plasma carbon black reactor as part of the smoke stream over the same time period is no greater than 0.5%.
137. The method of any preceding or following embodiment/feature/aspect, wherein the feedstock consists essentially of a liquid feedstock.
138. The method of any preceding or following embodiment/feature/aspect, wherein the feedstock comprises a liquid feedstock having an H:C ratio of at most 1.23, a Bureau of Mines Correlation Index (BMCI) of at least 100, and a specific gravity greater than 1.02
139. The method of any preceding or following embodiment/feature/aspect, wherein the feedstock comprises one or more of decant oil, slurry oil, coker oil, coal tar, coal tar distillate fractions, ethylene cracker residue, and phenol cracker residue.
140. The method of any preceding or following embodiment/feature/aspect, wherein the feedstock comprises a feedstock having at least one of an H:C ratio greater than 1.23, a BMCI less than 100, and a specific gravity of at least 1.02.
141. The method of any preceding or following embodiment/feature/aspect, wherein the feedstock comprises one or more of a tire pyrolysis oil, a plastic pyrolysis oil, a recycled oil, an algal oil, a plant-derived oil, an oil derived from pyrolysis of municipal solid waste, an oil derived from the pyrolysis or decay of biomass (e.g., animal or vegetable) or agricultural waste, an oil derived from the processing of pulp or paper production byproducts vegetable or other plant-derived oil, a bio-sourced ethanol, a plant- or animal-produced wax or resin, an oil rendered from animal fat, an algal oil, an oil rendered from the pyrolysis of sewage sludge or agricultural waste, a byproduct liquid from processing of a biogenic material, a liquid produced by hydrothermal liquefaction of a biomaterial, a rubber, or a plastic, a crude tall oil, a tall oil rosin, a tall oil pitch, or a tall oil fatty acid, an oil produced from recycled material, an oil derived from the pyrolysis of off-quality, rejected, or end-of-life tires, an oil derived from the pyrolysis of discarded or recycled plastics or rubber products, an oil derived from the pyrolysis of municipal solid waste, and an oil derived from the pyrolysis of biomass.
142. The method of any preceding or following embodiment/feature/aspect, wherein the feedstock comprises blend of liquid hydrocarbon and a hydrocarbon that is a gas a room temperature and pressure.
143. The method of any preceding or following embodiment/feature/aspect, wherein the feedstock has a flash point of at least 40 degC.
144. The method of any preceding or following embodiment/feature/aspect, wherein the feedstock comprises a liquid feedstock having up to 50 wt % dispersed particulate matter, for example, from 1 wt % to 5 wt %, from 5 wt % to 15 wt %, from 15 wt % to 25 wt %, from 25 wt % to 35 wt %, from 35 wt % to 45 wt %, or from 40 wt % to 50 wt %.
145. The method of any preceding or following embodiment/feature/aspect, wherein the particulate matter comprises biochar, crumb rubber, or reclaimed carbon.
146. The method of any preceding or following embodiment/feature/aspect, wherein the particulate matter comprises fumed silica, precipitated silica, alumina, iron compounds, iron oxide compounds, iron oxide, calcium carbonate, clay, mineral silicates, alkali silicates, sand, charcoal fines, coal fines, or carbon black.
147. The method of any preceding or following embodiment/feature/aspect, further comprising adding additional gas to the hot carrier gas stream prior to combining.
148. The method of any preceding or following embodiment/feature/aspect, further comprising introducing an oxygenous gas comprising one or more of water vapor, oxygen gas, carbon dioxide, ozone, sulfur dioxide, molybdenum trioxide, and oxides of nitrogen to one or more of the gas stream, the hot carrier gas stream, and the mixture of the hot carrier gas stream and the feedstock.
149. The method of any preceding or following embodiment/feature/aspect, wherein introducing is continuous or periodic.
150. The method of any preceding or following embodiment/feature/aspect, wherein the oxygenous gas is fed in a bifluid nozzle also used to inject the feedstock.
151. The method of any preceding or following embodiment/feature/aspect, wherein the oxygenous gas is part of the gas stream in which the plasma is generated.
152. The method of any preceding or following embodiment/feature/aspect, wherein the carbon black is produced in a reaction zone of a plasma carbon black reactor, and wherein the oxygenous gas is introduced to the mixture via porosity in walls of the reaction zone of a plasma carbon black reactor.
153. The method of any preceding or following embodiment/feature/aspect, wherein the feedstock and the oxygenous gas are introduced to the hot carrier gas stream using a bi-fluid nozzle.
154. The method of any preceding or following embodiment/feature/aspect, wherein the oxygenous gas is introduced in a single location or plane of the plasma carbon black reactor.
155. The method of any preceding or following embodiment/feature/aspect, wherein metal oxide particles are injected into one or more of the gas stream, the hot carrier gas stream, and the mixture of the hot carrier gas stream and the feedstock, and wherein introducing comprises allowing the metal oxide particles to sublimate to generate the oxygenous gas.
156. The method of any preceding or following embodiment/feature/aspect, wherein the carbon black is produced in a reaction zone of a plasma carbon black reactor, and wherein the method further comprises, during combining, cooling a wall of the reaction zone via transpiration cooling.
157. The method of any preceding or following embodiment/feature/aspect, wherein generating is performed in a plasma zone of a plasma carbon black reactor, and wherein the mixture of the hot carrier gas stream and the feedstock passes through a reaction zone in fluidic communication with the plasma zone, wherein the method further comprises introducing a downstream gas stream to the reaction zone, wherein the gas comprises one or more of nitrogen, argon, carbon dioxide, water vapor, or carbon monoxide.
158. The method of any preceding or following embodiment/feature/aspect, wherein the downstream gas stream is swirled.
159. The method of any preceding or following embodiment/feature/aspect, wherein the downstream gas stream is introduced with sufficient pressure to adjust recirculation of the mixture of the hot carrier gas stream and the feedstock.
160. The method of any preceding or following embodiment/feature/aspect, wherein the downstream gas stream further comprises one or more of water vapor, oxygen gas, carbon dioxide, ozone, sulfur dioxide, molybdenum trioxide, and oxides of nitrogen.
161. The method of any preceding or following embodiment/feature/aspect, wherein the carbon black is produced in a reaction zone of a plasma carbon black reactor, and wherein the method further comprises directing an abrasive particulate through the reaction zone, a) wherein directing is performed simultaneously with generating, introducing, and combining or b) wherein generating, introducing, and combining are performed simultaneously and wherein directing is alternated with generating, introducing, and combining at predetermined intervals.
162. The method of any preceding or following embodiment/feature/aspect, further comprising quenching the production of carbon black; separating the carbon black from the resulting tail gas; and recycling at least a portion of the tail gas for use as at least a portion of the gas stream.
163. The method of any preceding or following embodiment/feature/aspect, wherein recycling comprises combusting the tail gas and directing at least a portion of the combusted tail gas for use as at least a portion of the gas stream.
164. The method of any preceding or following embodiment/feature/aspect, wherein directing comprises dewatering the tail gas and directing a least a portion of the dewatered tail gas for use as at least a portion of the gas stream.
165. The method of any preceding or following embodiment/feature/aspect, wherein the portion of the dewatered tail gas comprises SOₓ.
166. The method of any preceding or following embodiment/feature/aspect, further comprising contacting the combusted tail gas with an aqueous slurry of limestone, lime, or alkaline sorbent to produce gypsum and a flue gas having 85-95% less moisture than the combusted tail gas, and wherein directing comprises directing at least a portion of the flue gas for use as at least a portion of the gas stream.
167. The method of any preceding or following embodiment/feature/aspect, wherein recycling comprises separating hydrogen from the tail gas and using the hydrogen to generate electricity.
168. The method of any preceding or following embodiment/feature/aspect, further comprising modifying a surface chemistry or a microstructure of the carbon black.
169. The method of any preceding or following embodiment/feature/aspect, further comprising one or more of modifying the carbon black to attach an organic group, oxidizing the carbon black, or etching the carbon black.
170. The method of any preceding or following embodiment/feature/aspect, wherein the carbon black is produced in a plasma carbon black reactor, wherein the mass ratio of solid carbon that builds up in the plasma carbon black reactor over a period of 8 hours with respect to the particulate carbon that leaves the plasma carbon black reactor over the same time period is no greater than 0.5%.
171. The method of any preceding or following embodiment/feature/aspect, wherein a tail gas is generated in conjunction with the generation of the carbon black, wherein the method further comprises combusting the tail gas, dewatering the combusted tail gas to produce a dewatered gas stream, and using at least a portion of the dewatered gas stream as at least a portion of the gas stream during generating a plasma.
172. The method of any preceding or following embodiment/feature/aspect, wherein dewatering the combusted tail gas comprises contacting with an aqueous slurry of limestone, lime, or alkaline sorbent to produce gypsum and a flue gas having 85-95% less moisture than the combusted tail gas, and wherein using comprises using at least a portion of the flue gas as at least a portion of the gas stream.
173. The method of any preceding or following embodiment/feature/aspect, wherein an amount of 325 mesh sieve residue (ASTM D1514) in carbon black produced over an eight hour period of continuous operation, measured once per hour, averages no more than 2400 ppm/hour by mass.
174. The method of any preceding or following embodiment/feature/aspect, wherein the feedstock has a flashpoint of at least 40 °C.
175. The method of any preceding or following embodiment/feature/aspect, wherein the feedstock contains at least 0.5% O atoms by mass.
176. The method of any preceding or following embodiment/feature/aspect, wherein the gas traffic is at least 0.05 kmol/kg carbon black.
177. The method of any preceding or following embodiment/feature/aspect, wherein the carbon black has a toluene extractable value less than 0.5%.
178. The method of any preceding or following embodiment/feature/aspect, wherein the net energy input is no greater than 20 kWh/kg carbon black, for example, at most 9 kWh/kg carbon black or at most 6 kWh/kg carbon black.
179. The method of any preceding or following embodiment/feature/aspect, wherein the net energy input is at least 1 kWh/kg carbon black.
180. The method of any preceding or following embodiment/feature/aspect, further comprising directing waterglass into the plasma.
181. The method of any preceding or following embodiment/feature/aspect, wherein generating a plasma in a gas stream comprises generating a plasma in a gas stream that is carrying particulate material, wherein at least a portion of the particulate material is transformed into one or more vapor phase species during generating.
182. The method of any preceding or following embodiment/feature/aspect, wherein the particulate material comprises silica, and wherein at least a portion of the particulate material is converted to gaseous SiO.
183. The method of any preceding or following embodiment/feature/aspect, wherein the particulate material comprises sand, clay, an aluminosilicate, or any combination of the above.
184. The method of any preceding or following embodiment/feature/aspect, further comprising introducing an oxygenous gas comprising one or more of water vapor, oxygen gas, carbon dioxide, ozone, sulfur dioxide, molybdenum trioxide, and oxides of nitrogen to the hot carrier gas prior to combining.
185. The present invention further relates to a carbon black produced according to the method of any preceding embodiment/feature/aspect.
186. The present invention further relates to an apparatus for producing carbon black, comprising:
   first and second plasma zones and a reaction zone, the reaction zone having an upstream end and a downstream end;
   a first plasma transport zone providing fluidic communication between the first plasma zone and the reaction zone and having an outlet;
   a second plasma transport zone providing fluidic communication between the second plasma zone and the reaction zone and having an outlet;
   the first and second plasma transport zones each being configured to direct a fluid along first and second axes, respectively, the first and second axes being at an angle of 30-90 deg with respect to the upstream end, the outlets being disposed on a common axis at a perpendicular angle to the reaction zone; and
   a plurality of feedstock injectors configured to direct a fluid towards a predetermined location in the reaction zone that is between the two outlets or downstream from the two outlets.
187. The apparatus of any preceding or following embodiment/feature/aspect, wherein one or both of the first and second plasma zones comprise a transferred arc system.
188. The apparatus of any preceding or following embodiment/feature/aspect, wherein an anode of the transferred arc system comprises a compressed bed of carbonaceous material.
189. The apparatus of any preceding or following embodiment/feature/aspect, wherein an anode of the transferred arc system comprises silicon, iron, aluminosilicates, magnesium oxide, yttria-stabilized zirconia, or molten salts
190. The apparatus of any preceding or following embodiment/feature/aspect, wherein one or both of the first and second plasma zones comprise a non-transferred arc system.
191. The apparatus of any preceding or following embodiment/feature/aspect, wherein at least one electrode for either or both of the first and second plasma zones is configured to be fed into the plasma zone from an exterior of the apparatus through a wall of the apparatus.
192. The present invention further relates to an apparatus for heating a gas with the use of a plasma, comprising:
   a tubular inner chamber defined by an inner wall and having an inlet end and an outlet end;
   an outer chamber in the form of at least one cylindrical shell between an outer wall and the inner wall, the outer chamber being in fluidic communication with the inner chamber at the inner chamber inlet end;
   an electrode disposed at the inner chamber inlet end and oriented along a central axis of the inner chamber; and
   an electrode disposed at the outlet end.
193. The apparatus of any preceding or following embodiment/feature/aspect, wherein the electrode at the outlet end is oriented along a central axis of the inner chamber.
194. The apparatus of any preceding or following embodiment/feature/aspect, wherein the two electrodes are part of a transferred arc system, and wherein the electrode at the outlet end comprises a) a compressed bed of carbonaceous material, b) one or more of silicon, iron, aluminosilicates, magnesium oxide, yttria-stabilized zirconia, and molten salts, or both a) and b).
195. The apparatus of any preceding or following embodiment/feature/aspect, further comprising an inner chamber outlet that is not parallel to the central axis of the inner chamber.
196. The apparatus of any preceding or following embodiment/feature/aspect, wherein the inner wall further comprises a plurality of protrusions directed into the outer chamber.
197. The apparatus of any preceding or following embodiment/feature/aspect, further comprising a baffle or swirl vane disposed at the inner chamber inlet end that causes a gas traveling from the outer chamber to the inner chamber to swirl.
198. The apparatus of any preceding or following embodiment/feature/aspect, further comprising a passageway from the outer chamber to the inner chamber having a baffle or swirl vane that directs a gas traveling from the outer chamber along an interior surface of the inner wall.
199. The apparatus of any preceding or following embodiment/feature/aspect, wherein an opening from the outer chamber to the inner chamber directs a gas traveling from the outer chamber at a tangent to an interior surface of the inner wall.
200. The apparatus of any preceding or following embodiment/feature/aspect, further comprising an intermediate wall disposed between at least a portion of the inner wall and at least a portion of the outer wall and dividing the outer chamber into two cylindrical shells in fluidic communication.
201. The present invention further relates to a transferred arc plasma apparatus for producing carbon black, comprising:
   a plasma zone having an inlet to receive a gas and an outlet in fluidic communication with a reaction zone which the carbon black is produced;
   an electrode disposed in the plasma zone; and
   an anode bed disposed in the plasma zone and opposed to the electrode, an axis defined by the electrode and the anode bed being perpendicular to a direction of gas flow through the plasma zone;
   the anode bed comprising one or more of silicon, iron, aluminosilicates, magnesium oxide, yttria stabilized zirconia, or molten salts.
202. The apparatus of any preceding or following embodiment/feature/aspect, further comprising a compressed bed of carbonaceous material disposed over the anode bed.
203. The apparatus of any preceding or following embodiment/feature/aspect, wherein the electrode is configured to be fed into the plasma zone from an exterior of the apparatus through a wall of the apparatus.
204. The apparatus of any preceding or following embodiment/feature/aspect, wherein the plasma zone has a longitudinal axis that is colinear with a longitudinal axis of the reaction zone.
205. The apparatus of any preceding or following embodiment/feature/aspect, wherein the reaction zone is cylindrical and the fluidic communication is provided by a conduit that enters the reaction zone within 10 degrees of a tangent to a wall of the reaction zone, for example, within 5 degrees or within 2 degrees or within 1 degree.
206. The apparatus of any preceding or following embodiment/feature/aspect, wherein the fluidic communication is provided by a conduit comprising a throat having an interior diameter less than an interior diameter of the reaction zone.

The present embodiments will be further clarified by the following examples which are intended to be only exemplary in nature

### EXAMPLES

### Example 1

A set of plasma carbon black reactors were manufactured. All of these plasma carbon black reactors used a custom DC powered arc plasma torch having a tungsten cathode and copper anode powered by four 50 kW power supplies connected in series and started with a high frequency arc starter. In the torch, stabilization was provided by swirling the primary plasma gas. The hot carrier gas issuing from the torch was then directed into a variety of reactor configurations as described below. Each of these mixed the hot carrier gas with a carbon black feedstock. The feedstock was either liquid feedstock (1-methylnaphthalene) or a gaseous feedstock, natural gas, as indicated in Table 2 below. The exit of the reaction zone, e.g., reactor zone 220, connected to a quenching device, which sprayed in water to halt the reaction and make the smoke stream safe for carbon black sample collection. Carbon black samples were collected using a simple cyclone separator. The separated tailgas or smoke was then incinerated.

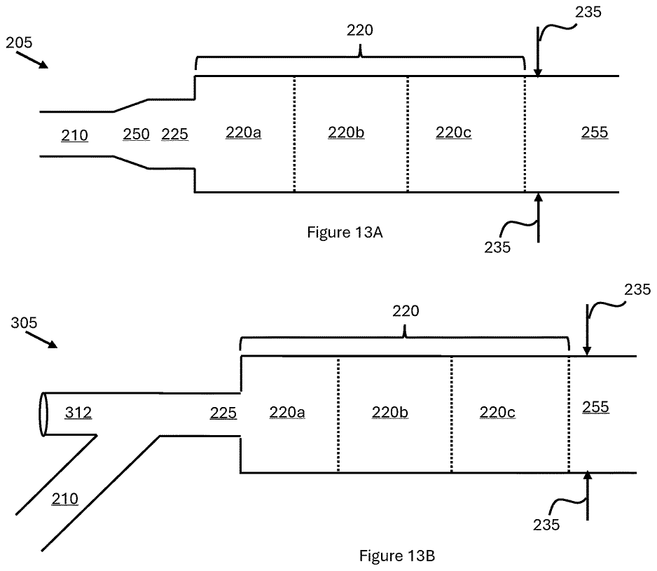

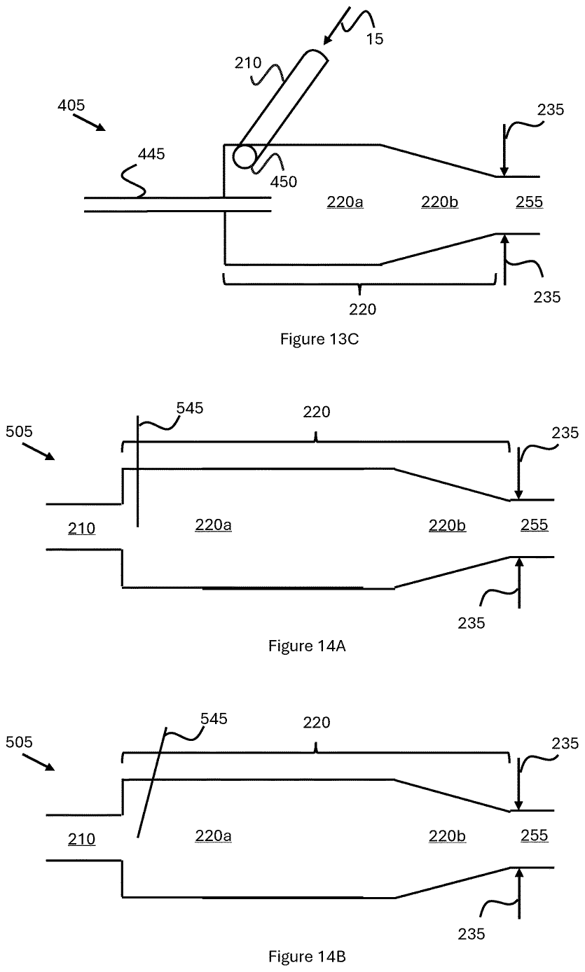

FIGS. 13-14 provide a schematic reference for plasma carbon black reactors used in the examples. In all the plasma carbon black reactors 205 (FIG. 13A), 305 (FIG. 13B), 405 (FIG. 13C), and 505 (FIG. 14), hot carrier gas travels from a water cooled plasma zone 210 to a reactor zone 220. Reactor zone 220 was a refractory-lined (castable alumina) steel shell. The specific configurations of reactor zone 220 for the various reactor configurations are given below. In various examples, reactor zone 220 was subdivided into two or more sections (first reactor zone section 220a, second reactor zone section 220b, and third reactor zone section 220c) having different diameters. After reactor zone 220, a quenching piece was attached. This was a water-cooled metal cylinder with nozzles that sprayed water into the smoke stream, cooling it and stopping further reaction. The quench section was 6 feet (1.8 m) long with radial quenching. The reactor zone lengths given below do not include the 5.1 cm gap from the entrance to the quench section to the injection of the quench water 235. This quench section 255 was used in all reactor configurations. A simple cyclone was used to collect carbon black product from the smoke stream.

Plasma carbon black reactor 205 (FIG. 13A) provides a schematic for Reactor Configurations 1-8. Plasma carbon black reactor 205 employs axial delivery of plasma from torch 210 through diffuser 250 and throat 225 to reactor zone 220 and then to quench zone 255. Diffuser 250 included a water-cooled steel shell lined with castable alumina refractory (Alfrax) formed into an approximately 7° cone, with a ⅝-inch (1.6 cm) inner diameter on the inlet side, and a 1-inch (2.5 cm) inner diameter on the outlet side. The purpose of diffuser 250 was to smoothly expand the hot carrier gas leaving the water cooled plasma torch 210 to the diameter of the feedstock injection throat 225.

Throat 225 was a device connected to diffuser 250, whose purpose was to inject feedstock into the hot carrier gas, and mix these two streams. Throat 225 included a water cooled ring with feedstock injection nozzles in one of two configurations. In the first configuration, the nozzles were arranged “axially”, at a 10-degree angle from the longitudinal axis, similar to the configuration shown for feedstock 30 in FIG. 6C. In the second configuration, the feedstock nozzles were arranged radially, pointed at a right angle to the longitudinal axis of reactor zone 220, similar to the configuration shown for feedstock 30 in FIG. 1. In some cases these nozzles were bifluid. In other cases they were used with only a liquid feedstock. Table 2 specifies which configuration (axial vs. radial) was used in which experiment. Where a bifluid nozzle was used, Table 2 specifies the gas species and rate (no gas for liquid-only nozzles). The downstream end of throat 225 opened into reactor zone 220.

In Reactor Configuration 1, reactor zone 220 was a four inch (10.2 cm) diameter steel shell lined with castable refractory to give an inner diameter of 2 inches (5.1 cm) and was 48 inches (121.9 cm) long. Reactor Configuration 2 was similar to Reactor Configuration 1, except that the refractory was cast so that the inner diameter of reactor zone 220 was 3 inches (7.6 cm) and the length was five feet (152.4 cm). While the diameter of reactor zone 220 was uniform in Reactor Configurations 1 and 2, Reactor Configuration 3 employed first and second reactor zone sections 220a and 220b. In Reactor Configuration 3, first reactor zone section 220a had an inner diameter of 2 inches (5.1 cm) and was 6 inches (15.2 cm) long. Second reactor zone section 220b was 3 inches (7.6 cm) in diameter and five feet (152.4 cm) long. In Reactor Configurations 1-3, the entire length of reactor zone 220 was water-cooled.

Reactor configurations 4-8 also employed multiple reactor zone sections having different interior diameters but the steel shell of reactor zone 220 was about 6 inches (15.2 cm) in diameter. However, not all the sections of reactor zone 220 were actively cooled. Reactor Configuration 4 had a first reactor zone section 220a 6 inches (15.2 cm) in length with an inner diameter of 3 inches (7.6 cm). Second reactor zone section 220b had an inner diameter of 4.4 inches (11.2 cm) and was 12 inches (30.5 cm) long. Third reactor zone section 220c was 48 inches (121.9 cm) long and 5.4 inches (13.7 cm) in diameter. First and second reactor zone sections 220a and 220b were water-cooled; third reactor zone section 220c was not.

Reactor Configuration 5 had a water-cooled first reactor zone section 220a that was 6 inches (15.2 cm) in length with a 3 inch (7.6 cm) inner diameter. Second reactor zone section 220b had an inner diameter of 4.4 inches (11.2 cm) and a length of 12 inches (30.5 cm). Third reactor zone section 220c had an inner diameter of 5.4 inches (13.7 cm) and was 48 inches (121.9 cm) long. Second and third reactor zone sections 220b and 220c were not water-cooled.

Reactor Configuration 6 had a water-cooled first reactor zone section 220a that was 6 inches (15.2 cm) in length with a 3 inch (7.6 cm) inner diameter. Second reactor zone section 220b had an inner diameter of 5.4 inches (13.7 cm) and a length of 60 inches (152.4 cm). Third reactor zone section 220c had an inner diameter of 3 inches (7.6 cm) and was 12 inches (30.5 cm) long. Second and third reactor zone sections 220b and 220c were not water-cooled.

Reactor Configuration 7 used a first reactor zone section 220a with a 5.4 inch (13.7 cm) inner diameter that was 60 inches (152.4 cm) long. Second reactor zone section 220b had an inner diameter of 3 inches (7.6 cm) and was 12 inches (30.5 cm) long. Third reactor zone section 220c was a contracting cone, which went from a 5.4 inch (13.7 cm) inner diameter to a 3 inch (7.6 cm) inner diameter over a length of 12 inches (30.5 cm). No sections of reactor zone 220 in Reactor Configuration 7 were actively cooled.

Reactor Configuration 8 was similar to Reactor Configuration 7 but interposed a preliminary reactor zone section (not shown) between throat 225 and first reactor zone section 220a. This preliminary reactor zone section was water-cooled and 6 inches (15.2 cm) long, with an interior diameter of 3 inches (7.6 cm).

Reactor Configurations 9, 10, and 11 used a reactor 305 having the “Y-piece” configuration shown in FIG. 13B, in which the outlet of plasma torch 210 joined a sight port tube 312 at a 45-degree angle. This “Y-piece” connector was made with a 2-inch (5.1 cm) outer steel shell, cast with alumina refractory down to a 1-inch (2.5 cm) inner diameter. The steel shell was water-cooled. The exit of the Y-piece was connected to throat 225 which was configured as described in connection with FIG. 13A (e.g., with either axial or the radial nozzle configurations using bifluid or liquid nozzles).

In Reactor Configuration 9, first reactor zone section 220a was configured as an expanding cone, made of castable alumina refractory, with an inlet inner diameter of 1 inch (2.5 cm), an outlet inner diameter of 5 inches (12.7 cm), and a steel shell about 6 inches (15.2 cm) in diameter that was water-cooled. Insulating mineral-wool felt was placed between the castable layer and the water-cooled steel shell. First reactor zone section 220a was 18 inches (45.7 cm) long. Second reactor zone section 220b had an inner diameter of 5 inches (12.7 cm) and was 43 inches (109.2 cm) long. Its steel shell was also water-cooled. Third reactor zone section 220c had the same dimensions as the contracting exit cone described for third reactor zone section 220c of Reactor Configuration 7 but was water-cooled. Reactor Configuration 10 included only two reactor zone sections. First reactor zone section 220a had an inner diameter of 5 inches (12.7 cm) and a length of 48 inches (121.9 cm) whose steel shell was water-cooled. Second reactor zone section 220b had the same dimensions as the contracting exit cone described for third reactor zone section 220c of Reactor Configuration 7 but was water-cooled. Reactor Configuration 11 was the same as Reactor Configuration 10, except that a layer of mineral felt was inserted between the alumina refractory layer and the water-cooled shell in the first reactor zone section 220a.

Reactor Configuration 12 employed the tangential introduction of plasma into reactor zone 20 described in connection with FIGS. 7A and 7B. As discussed in connection with FIGS. 7A and 7B, tangential plasma injection causes the injected hot gas to swirl along the inside edge of the reactor wall. The dimensions of Reactor Configuration 12 are described with reference to reactor 405 in FIG. 13C.

In Reactor Configuration 12, the feedstock was injected using a bifluid spray in a water-cooled lance (stinger 445). This was a metal tube, surrounded by a water-cooled jacket, which carried liquid feedstock and an atomizing gas to a simple orifice at the end of the tube. Stinger 445 had an outer diameter of ¾ inch (1.9 cm). In Reactor Configuration 12, first reactor zone section 220a was a water-cooled refractory-lined tunnel of 5 inches (12.7 cm) inner diameter that extended 32.2 inches (81.8 cm) after introduction of the plasma gas at the wall of the first reactor zone section 220a. The end of stinger 445 was 6 inches (15.2 cm) from the center point of the opening 450 from which hot carrier gas 15 coming from a plasma zone 210 entered first reactor zone section 220a. Second reactor zone section 220b had the same dimensions as the contracting conical exit section described for third reactor zone section 220c of Reactor Configuration 7 and was water-cooled.

In Reactor Configuration 13, the plasma torch was again oriented along the long axis of the reactor 505, as shown in FIGS. 14A and 14B. However, there was no diffuser and no throat. Rather, a stinger 545 was inserted radially into reactor zone 220. Two configurations were used for the stinger. In one (FIG. 14A), stinger 545 was mounted such that it injected at a right angle to the long axis of reactor zone 220 and configured for liquid-only feedstock. In the other (FIG. 14B), this was offset by about 20 degrees, as shown in FIG. 14B, so that the end of stinger 545 pointed toward plasma zone 210. This angled stinger 545 was configured for bifluid introduction of feedstock. When the stinger 545 was inserted at a right angle to the reactor zone axis, the tip was about 1 inch (2.5 cm) downstream of the exit of plasma zone 510. The angled stinger 545 shown in FIG. 14B brought the tip to within ¼ inch (0.6 cm) of the exit. In both cases the tip was within about 0.5 inches (1.3 cm) of the long axis (centerline) of reactor zone 220. In addition, Reactor Configuration 13 included first reactor zone section 220a, with a steel shell that was about 6 inches (15.2 cm) in diameter, filled with castable refractory so that its inner diameter was 5 inches (12.7 cm). First reactor zone section 220a was 3 ft (91.4 cm) long and was not actively cooled. Second reactor zone section 220b had the same configuration as the contracting conical exit section described for third reactor zone section 220c of Reactor Configuration 7, with no active cooling.

The examples were operated as follows, and as summarized in Table 2. A carrier gas was fed to the plasma torch. The carrier gas was the species given, at the rate given. A tracer gas was also typically fed to the torch. In some cases oxygen was added to the carrier gas as indicated.

Either liquid 1-methylnaphthalene or natural gas was fed as the feedstock using the injection method (throat, or injector type (radial or stinger)) indicated. The high temperature of the hot gas produced by the plasma torch drove pyrolysis of the feedstock to carbon and hydrogen.

Reactor atomic ratios O:C and H:C were calculated from the inputs. These reflect the ratio of O atoms to C atoms, or H atoms to C atoms, fed to the entire system (regardless of where in the plasma carbon black reactor they entered).

To calculate the values of net energy input and gas traffic per unit solid carbon produced, it was necessary to know or estimate the yield of the carbon from the feedstock. Yield is defined as the mass of solid carbon produced per mass of feedstock introduced, expressed as kg C/kg FS. With liquid feedstock, yield was generally near-complete. For Examples 37, 61, 62, and 63, yield was measured by gas chromatography, to confirm high yields. The average yield of these cases is 0.9 kg/kg, which was used as the yield estimate for all cases where oxygen was not present.

For cases without oxygen present, the gas traffic as reported in Table 2 is calculated in the following way. First, the amount of carrier gas fed to the reactor was noted. The carrier gas was a mixture of either Ar and N₂, or Ar and H₂. It was assumed that the carrier gas did not react.

Next, a yield of 0.9 kg C/kg feedstock was assumed as noted above.

A mole balance on atomic carbon was calculated. It was assumed that all carbon appearing in the gas phase became CH₄ or C₂H₂, and the flow of these species in the mole balance was estimated as described below:
F_{C,tot}=total molar flow of carbon atoms into the reactor in kmol/h
F_{C,(s)}=total molar flow of carbon atoms in carbon black
F_{C, C2H2}=molar flow of carbon atoms in C₂H₂
F_{C,CH4}=molar flow of carbon atoms in CH₄
F_{CH4}=molar flow of CH₄
F_{C2H2}=molar flow of C₂H₂
a=F_{CH4}/F_{C2H2}

The below equations then follow by stoichiometric arguments,
F_{CH4}=F_{C},CH4
F_{C,tot}=F_{C(s)}+F_{C,C2H2}+F_{C,CH4}
F_{C2H2=2}F_{C,C2H2}
F_{CH4}=aF_{C2H2}
F_{CH4}=(F_{C,tot}−F_{C(s)})/(1+(1/(2a))
F_{C2H2}=(1/a)F_{CH4}

In the above equations, F_{C,tot} is known. F_{C(s)} is determined by the yield measurement or estimate. The ratio a is assumed. In the examples, a was set at 0.75.

For cases where oxygen was present, gas traffic was calculated in the following way:

Any N₂ and Ar in the carrier gas were treated as non-reacting. It was assumed, based on experience with yield measurements in furnace black processes, that with oxygen present, the yield followed the equation Yield=0.93−0.76*(Reactor O:C). The yield defines the amount of feedstock that becomes carbon black, and the balance of feedstock oxidizes to gas phase species. We assumed that the feedstock that reacted to carbon black reacted according to the equation:

C₁₁H₁₀→11C(s)+5H₂ (g)

It was assumed that the feedstock that did not form solid carbon reacted according to the equation:

C₁₁H₁₀+11/2O₂→11CO+5H₂

If there was any remaining O₂ it was assumed to have reacted with H₂ to form H₂O. The amount of formed H₂ and CO and H₂O by these reactions was then added to the carrier gas flow rate to calculate the gas traffic.

To calculate the amount of net energy delivered, the inlet and outlet temperatures and flowrates of all cooling water flows were measured. From this data the heat lost to cooling water was calculated. The electrical energy going to the torch was measured, and the heat lost to the cooling water was subtracted from the electrical energy going to the torch to determine the net energy. Dividing the net energy by the reaction yield provides the net energy per kg C as reported.

The extent of reactor fouling (“reactor coke level”) was graded visually on a scale of 0 to 6, with 0 being the lowest. Samples of the carbon black produced were extracted with the cyclone separator. The resulting carbon black was characterized for one or more of surface area (iodine number according to ASTM D1510), tint strength (ASTM D3265), toluene discoloration (ASTM D1618), 325 mesh sieve residue (ASTM D1514), and toluene extractables (ASTM D1618). Even when measured, iodine number is not reported for samples having either a high (>1%) toluene extractable value or a low (<30%) value of toluene discoloration. Either of these characteristics indicate a large amount of unpyrolyzed feedstock on the surface of the carbon black. This distorts the interaction of the iodine with the carbon black surface and results in a measurement that does not properly reflect a surface area measurement that can be compared to the surface area of “cleaner” carbon blacks.

TABLE 2

| Example No. | | 1 | 2 | 3 | 4 | 5 | 6 | 7 | 8 |
|---|---|---|---|---|---|---|---|---|---|
| Carrier Gas | name | N2 | N2 | H2 | H2 | H2 | H2 | H2 | H2 |
| Carrier Gas Rate | kmol/h | 1.2 | 1.2 | 6.0 | 6.0 | 6.0 | 6.0 | 3.0 | 3.6 |
| Tracer Gas | name | Ar | Ar | Ar | Ar | Ar | Ar | Ar | Ar |
| Tracer Gas Rate | kmol/h | 0.30 | 0.30 | 0.39 | 0.15 | 0.15 | 0.15 | 0.15 | 0.16 |
| Liquid Feedstock | kg/h | 5.0 | 5.2 | 7.0 | 12.8 | 6.7 | 6.6 | 6.6 | 6.8 |
| Rate | | | | | | | | | |
| Nat. Gas Feed | kmol/h | 0.0 | 0.0 | 0.0 | 0.0 | 0.0 | 0.0 | 0.0 | 0.0 |
| Rate | | | | | | | | | |
| Added Oxygen | kmol/h | 0.0 | 0.0 | 0.0 | 0.0 | 0.0 | 0.0 | 0.0 | 0.0 |
| Rate | | | | | | | | | |
| Reactor | name | 1 | 1 | 1 | 1 | 1 | 1 | 1 | 2 |
| Configuration | | | | | | | | | |
| Throat or | name | Axial | Axial | Axial | Axial | Axial | Axial | Axial | Axial |
| Injector Type | | | | | | | | | |
| Used | | | | | | | | | |
| Bifluid Gas | name | None | None | None | None | None | None | None | None |
| Bifluid Gas Rate | Nm³/h | 0.0 | 0.0 | 0.0 | 0.0 | 0.0 | 0.0 | 0.0 | 0.0 |
| Gross Torch | kW | 57 | 59 | 93 | 138 | 143 | 186 | 109 | 121 |
| Power Input | | | | | | | | | |
| Net Power After | kW | 21 | 21 | 50 | 87 | 87 | 115 | 48 | 41 |
| Active Heat Loss | | | | | | | | | |
| Reactor O:C | num | 0.0 | 0.0 | 0.0 | 0.0 | 0.0 | 0.0 | 0.0 | 0.0 |
| Reactor H:C | num | 0.9 | 0.9 | 22.9 | 13.0 | 24.1 | 24.4 | 12.6 | 14.6 |
| Meas'd Yield | kg C/ | | | | | | | | |
| | kg FS | | | | | | | | |
| Net Energy Input | kWh/ | 5.0 | 4.8 | 8.5 | 8.2 | 15.5 | 20.9 | 8.7 | 7.2 |
| per kg C | kg C | | | | | | | | |
| Gas Traffic | kmol/ | 0.4 | 0.4 | 1.1 | 0.6 | 1.1 | 1.1 | 0.6 | 0.7 |
| | kg C | | | | | | | | |
| Reactor Coke | num | 6 | 6 | 0 | 6 | 6 | 6 | 6 | 6 |
| Level | | | | | | | | | |
| I2 Number | mg/g | 220 | 152 | | | | | | |
| Tint | num | 96 | 96 | | | | | | |
| Toluene | num | 90 | 100 | | | | 1 | 4 | |
| discoloration | | | | | | | | | |
| 325 Mesh | ppm | | | | | | | | |
| residue | | | | | | | | | |
| Toluene Extract | % | | | 5.4 | 15.6 | 9.2 | 1.2 | 1.3 | |

| Example No. | | 9 | 10 | 11 | 12 | 13 | 14 | 15 | 16 |
|---|---|---|---|---|---|---|---|---|---|
| Carrier Gas | name | H2 | H2 | H2 | H2 | H2 | H2 | H2 | H2 |
| Carrier Gas Rate | kmol/h | 3.6 | 3.6 | 4.8 | 3.6 | 6.0 | 3.6 | 6.0 | 6.0 |
| Tracer Gas | name | Ar | Ar | Ar | Ar | Ar | Ar | Ar | Ar |
| Tracer Gas Rate | kmol/h | 0.16 | 0.29 | 0.26 | 0.27 | 0.18 | 0.51 | 0.51 | 0.19 |
| Liquid | kg/h | 6.8 | 4.6 | 4.8 | 4.5 | 3.5 | 4.6 | 4.6 | 4.6 |
| Feedstock Rate | | | | | | | | | |
| Nat. Gas Feed | kmol/h | 0.0 | 0.0 | 0.0 | 0.0 | 0.0 | 0.0 | 0.0 | 0.0 |
| Rate | | | | | | | | | |
| Added Oxygen | kmol/h | 0.0 | 0.0 | 0.0 | 0.0 | 0.0 | 0.0 | 0.0 | 0.0 |
| Rate | | | | | | | | | |
| Reactor | name | 2 | 3 | 3 | 3 | 3 | 3 | 3 | 3 |
| Configuration | | | | | | | | | |
| Throat or | name | Axial | Axial | Axial | Axial | Radial | Radial | Radial | Radial |
| Injector Type | | | | | | | | | |
| Used | | | | | | | | | |
| Bifluid Gas | name | None | Ar | Ar | Ar | None | None | Ar | Ar |
| Bifluid Gas Rate | Nm³/h | 0.0 | 1.6 | 1.6 | 1.6 | 0.0 | 0.0 | 1.6 | 1.6 |
| Gross Torch | kW | 146 | 122 | 164 | 147 | 144 | 138 | 147 | 179 |
| Power Input | | | | | | | | | |
| Net Power After | kW | 59 | 43 | 66 | 147 | 144 | 51 | 61 | 79 |
| Active Heat Loss | | | | | | | | | |
| Reactor O:C | num | 0.0 | 0.0 | 0.0 | 0.0 | 0.0 | 0.0 | 0.0 | 0.0 |
| Reactor H:C | num | 14.4 | 21.1 | 26.6 | 21.3 | 44.5 | 20.9 | 34.3 | 34.3 |
| Meas'd Yield | kg C/ | | | | | | | | |
| | kg FS | | | | | | | | |
| Net Energy Input | kWh/ | 10.3 | 11.3 | 16.3 | 38.7 | 48.6 | 13.1 | 15.6 | 20.4 |
| per kg C | kg C | | | | | | | | |
| Gas Traffic | kmol/ | 0.7 | 1.1 | 1.3 | 1.1 | 2.1 | 1.1 | 1.7 | 1.6 |
| | kg C | | | | | | | | |
| Reactor Coke | num | 6 | 2 | 5 | 5 | 2 | 5 | 0 | 0 |
| Level | | | | | | | | | |
| I2 Number | mg/g | | | | | 130 | | 164 | 88 |
| Tint | num | | | | | | | | |
| Toluene | num | | | | 3 | | 2 | | |
| Discoloration | | | | | | | | | |
| 325 Mesh | ppm | | | | | | | | |
| Residue | | | | | | | | | |
| Toluene Extract | % | 1.4 | 1.3 | | | | | | |
| Example No. | | 17 | 18 | 19 | 20 | 21 | 22 | 23 | 24 |
| Carrier Gas | name | H2 | H2 | N2 | H2 | H2 | H2 | H2 | H2 |
| Carrier Gas Rate | kmol/h | 6.0 | 6.0 | 1.0 | 6.0 | 6.0 | 6.0 | 6.0 | 6.0 |
| Tracer Gas | name | Ar | Ar | Ar | Ar | Ar | Ar | Ar | Ar |
| Tracer Gas Rate | kmol/h | 0.19 | 0.19 | 0.16 | 0.21 | 0.24 | 0.36 | 0.34 | 0.34 |
| Liquid | kg/h | 6.8 | 9.1 | 0.0 | 9.1 | 9.2 | 9.1 | 18.1 | 18.1 |
| Feedstock Rate | | | | | | | | | |
| Nat. Gas Feed | kmol/h | 0.0 | 0.0 | 1.0 | 0.0 | 0.0 | 0.0 | 0.0 | 0.0 |
| Rate | | | | | | | | | |
| Added Oxygen | kmol/h | 0.0 | 0.0 | 0.0 | 0.0 | 0.0 | 0.0 | 0.0 | 0.0 |
| Rate | | | | | | | | | |
| Reactor | name | 3 | 3 | 3 | 4 | 4 | 5 | 6 | 7 |
| Configuration | | | | | | | | | |
| Throat or | name | Radial | Radial | Radial | Axial | Axial | Axial | Axial | Axial |
| Injector Type | | | | | | | | | |
| Used | | | | | | | | | |
| Bifluid Gas | name | Ar | Ar | None | None | None | None | None | None |
| Bifluid Gas Rate | Nm³/h | 1.6 | 1.6 | 0.0 | 0.0 | 0.0 | 0.0 | 0.0 | 0.0 |
| Gross Torch | kW | 149 | 150 | 63 | 126 | 148 | 151 | 150 | 139 |
| Power Input | | | | | | | | | |
| Net Power After | kW | 72 | 85 | 17 | 73 | 67 | 101 | 104 | 91 |
| Active Heat Loss | | | | | | | | | |
| Reactor O:C | num | 0.0 | 0.0 | 0.0 | 0.0 | 0.0 | 0.0 | 0.0 | 0.0 |
| Reactor H:C | num | 23.4 | 17.8 | 4.0 | 17.9 | 17.7 | 17.9 | 9.5 | 9.4 |
| Meas'd Yield | kg C/ | | | | | | | | |
| | kg FS | | | | | | | | |
| Net Energy Input | kWh/ | 12.5 | 11.2 | 1.6 | 9.6 | 8.7 | 13.3 | 6.9 | 6.0 |
| per kg C | kg C | | | | | | | | |
| Gas Traffic | kmol/ | 1.1 | 0.9 | 0.3 | 0.9 | 0.8 | 0.9 | 0.5 | 0.5 |
| | kg C | | | | | | | | |
| Reactor Coke | num | 5 | 5 | | | 5 | 0 | 4 | 6 |
| Level | | | | | | | | | |
| I2 Number | mg/g | | | | | | | 48 | |
| Tint | num | | | | | | | 46 | |
| Toluene | num | | | | | | | 94 | |
| Discoloration | | | | | | | | | |
| 325 Mesh | ppm | | | | | | | | 3700 |
| Residue | | | | | | | | | |
| Toluene Extract | % | 1.7 | 1.9 | | | 1.1 | 2.3 | 0.1 | 1.3 |

| Example No. | | 25 | 26 | 27 | 28 | 29 | 30 | 31 | 32 |
|---|---|---|---|---|---|---|---|---|---|
| Carrier Gas | name | H2 | H2 | H2 | N2 | N2 | N2 | N2 | N2 |
| Carrier Gas Rate | kmol/h | 6.0 | 6.0 | 6.0 | 1.6 | 1.6 | 1.6 | 1.6 | 1.6 |
| Tracer Gas | name | Ar | Ar | Ar | Ar | Ar | Ar | Ar | Ar |
| Tracer Gas Rate | kmol/h | 0.33 | 0.35 | 0.34 | 0.23 | 0.23 | 0.35 | 0.44 | 0.44 |
| Liquid | kg/h | 18.1 | 18.1 | 18.1 | 4.5 | 4.6 | 4.7 | 7.3 | 13.2 |
| Feedstock Rate | | | | | | | | | |
| Nat. Gas Feed | kmol/h | 0.0 | 0.0 | 0.0 | 0.0 | 0.0 | 0.0 | 0.0 | 0.0 |
| Rate | | | | | | | | | |
| Added Oxygen | kmol/h | 0.0 | 0.0 | 0.0 | 0.0 | 0.0 | 0.0 | 0.0 | 0.0 |
| Rate | | | | | | | | | |
| Reactor | name | 7 | 8 | 8 | 8 | 8 | 9 | 9 | 9 |
| Configuration | | | | | | | | | |
| Throat or | name | Axial | Axial | Axial | Radial | Radial | Radial | Radial | Radial |
| Injector Type | | | | | | | | | |
| Used | | | | | | | | | |
| Bifluid Gas | name | None | None | None | Ar | Ar | Ar | Ar | None |
| Bifluid Gas Rate | Nm³/h | 0.0 | 0.0 | 0.0 | 1.6 | 1.6 | 1.6 | 1.6 | 0.0 |
| Gross Torch | kW | 138 | 154 | 150 | 62 | 68 | 79 | 181 | 78 |
| Power Input | | | | | | | | | |
| Net Power After | kW | 90 | 100 | 96 | 22 | 27 | 31 | 135 | 24 |
| Active Heat Loss | | | | | | | | | |
| Reactor O:C | num | 0.0 | 0.0 | 0.0 | 0.0 | 0.0 | 0.0 | 0.0 | 0.0 |
| Reactor H:C | num | 9.4 | 9.4 | 9.4 | 0.9 | 0.9 | 0.9 | 0.9 | 0.9 |
| Meas'd Yield | kg C/ | | | | | | | | |
| | kg FS | | | | | | | | |
| Net Energy Input | kWh/ | 5.9 | 6.6 | 6.3 | 5.8 | 7.1 | 8.0 | 22.2 | 2.2 |
| per kg C | kg C | | | | | | | | |
| Gas Traffic | kmol/ | 0.5 | 0.5 | 0.5 | 0.5 | 0.5 | 0.5 | 0.4 | 0.2 |
| | kg C | | | | | | | | |
| Reactor Coke | num | 4 | 4 | 4 | 3 | 3 | 0 | 0 | 0 |
| Level | | | | | | | | | |
| I2 Number | mg/g | | | 67 | 331 | 259 | 276 | 222 | 104 |
| Tint | num | | | 91 | 89 | 89 | 119 | 114 | 94 |
| Toluene | num | | 60 | 85 | 97 | 97 | 100 | 100 | 100 |
| Discoloration | | | | | | | | | |
| 325 Mesh | ppm | 19000 | | 3100 | 22600 | 63700 | 8300 | 5300 | 1200 |
| Residue | | | | | | | | | |
| Toluene Extract | % | 0.8 | | 0.2 | | 0.2 | 0.1 | 0.2 | |

| Example No. | | 33 | 34 | 35 | 36 | 37 | 38 | 39 | 40 |
|---|---|---|---|---|---|---|---|---|---|
| Carrier Gas | name | N2 | N2 | N2 | N2 | N2 | N2 | N2 | N2 |
| Carrier Gas Rate | kmol/h | 1.6 | 1.6 | 1.6 | 1.6 | 1.6 | 1.6 | 1.6 | 1.6 |
| Tracer Gas | name | Ar | Ar | Ar | Ar | Ar | Ar | Ar | Ar |
| Tracer Gas Rate | kmol/h | 0.30 | 0.29 | 0.31 | 0.33 | 0.46 | 0.35 | 0.32 | 0.32 |
| Liquid | kg/h | 4.9 | 4.8 | 4.8 | 2.5 | 4.8 | 0.0 | 0.0 | 0.0 |
| Feedstock Rate | | | | | | | | | |
| Nat. Gas Feed | kmol/h | 0.0 | 0.0 | 0.0 | 0.0 | 0.0 | 1.6 | 1.6 | 1.6 |
| Rate | | | | | | | | | |
| Added Oxygen | kmol/h | 0.0 | 0.0 | 0.0 | 0.0 | 0.0 | 0.0 | 0.0 | 0.0 |
| Rate | | | | | | | | | |
| Reactor | name | 10 | 10 | 10 | 10 | 10 | 10 | 10 | 10 |
| Configuration | | | | | | | | | |
| Throat or | name | Axial | Axial | Axial | Axial | Axial | Axial | Axial | Axial |
| Injector Type | | | | | | | | | |
| Used | | | | | | | | | |
| Bifluid Gas | name | Ar | Ar | Ar | Ar | Ar | None | None | None |
| Bifluid Gas Rate | Nm³/h | 1.6 | 1.6 | 1.6 | 1.6 | 1.6 | 0.0 | 0.0 | 0.0 |
| Gross Torch | kW | 78 | 81 | 80 | 81 | 71 | 69 | 78 | 88 |
| Power Input | | | | | | | | | |
| Net Power After | kW | 27 | 29 | 29 | 29 | 16 | 22 | 26 | 36 |
| Active Heat Loss | | | | | | | | | |
| Reactor O:C | num | 0.0 | 0.0 | 0.0 | 0.0 | 0.0 | 0.0 | 0.0 | 0.0 |
| Reactor H:C | num | 0.9 | 0.9 | 0.9 | 0.9 | 0.9 | 4.0 | 4.0 | 4.0 |
| Meas'd Yield | kg C/ | | | | | 0.93 | | | |
| | kg FS | | | | | | | | |
| Net Energy Input | kWh/ | 6.5 | 7.3 | 7.3 | 13.9 | 3.9 | 1.7 | 1.7 | 2.1 |
| per kg C | kg C | | | | | | | | |
| Gas Traffic | kmol/ | 0.5 | 0.5 | 0.5 | 1.0 | 0.6 | 0.1 | 0.1 | 0.1 |
| | kg C | | | | | | | | |
| Reactor Coke | num | 0 | 0 | 0 | 0 | 0 | | | |
| Level | | | | | | | | | |
| I2 Number | mg/g | 161 | 155 | 182 | 192 | 186 | | | |
| Tint | num | 98 | 98 | 96 | 96 | 89 | | | |
| Toluene | num | 97 | 99 | 95 | 95 | 100 | | | |
| Discoloration | | | | | | | | | |
| 325 Mesh | ppm | 1700 | 3500 | 1900 | 2400 | 1100 | | | |
| Residue | | | | | | | | | |
| Toluene Extract | % | 0.1 | 0.1 | 0.1 | 0.1 | 0.1 | 2.9 | 4.1 | 1.6 |

| Example No. | | 41 | 42 | 43 | 44 | 45 | 46 | 47 | 48 |
|---|---|---|---|---|---|---|---|---|---|
| Carrier Gas | name | H2 | H2 | N2 | N2 | N2 | N2 | N2 | N2 |
| Carrier Gas Rate | kmol/h | 6.0 | 6.0 | 1.6 | 1.6 | 1.6 | 1.6 | 2.4 | 2.4 |
| Tracer Gas | name | Ar | Ar | N2 | N2 | N2 | N2 | Ar | Ar |
| Tracer Gas Rate | kmol/h | 0.34 | 0.44 | 0.00 | 0.00 | 0.00 | 0.00 | 0.30 | 0.30 |
| Liquid | kg/h | 21.6 | 18.0 | 4.6 | 4.6 | 4.5 | 4.5 | 4.6 | 4.5 |
| Feedstock Rate | | | | | | | | | |
| Nat. Gas Feed | kmol/h | 0.0 | 0.0 | 0.0 | 0.0 | 0.0 | 0.0 | 0.0 | 0.0 |
| Rate | | | | | | | | | |
| Added Oxygen | kmol/h | 0.0 | 0.0 | 0.0 | 0.0 | 0.0 | 0.0 | 0.0 | 0.0 |
| Rate | | | | | | | | | |
| Reactor | name | 11 | 11 | 12 | 12 | 12 | 12 | 12 | 12 |
| Configuration | | | | | | | | | |
| Throat or | name | Radial | Radial | Stinger | Stinger | Stinger | Stinger | Stinger | Stinger |
| Injector Type | | | | | | | | | |
| Used | | | | | | | | | |
| Bifluid Gas | name | Ar | Ar | Ar | Ar | Ar | Ar | Ar | Ar |
| Bifluid Gas Rate | Nm³/h | 1.6 | 1.6 | 1.6 | 1.6 | 1.6 | 1.6 | 1.6 | 1.6 |
| Gross Torch | kW | 162 | 156 | 53 | 64 | 60 | 60 | 91 | 81 |
| Power Input | | | | | | | | | |
| Net Power After | kW | 85 | 84 | 16 | 25 | 27 | 23 | 37 | 35 |
| Active Heat Loss | | | | | | | | | |
| Reactor O:C | num | 0.0 | 0.0 | 0.0 | 0.0 | 0.0 | 0.0 | 0.0 | 0.0 |
| Reactor H:C | num | 8.0 | 9.5 | 0.9 | 0.9 | 0.9 | 0.9 | 0.9 | 0.9 |
| Meas'd Yield | kg C/ | | | | | | | | |
| | kg FS | | | | | | | | |
| Net Energy Input | kWh/ | 4.7 | 5.6 | 4.2 | 6.5 | 7.1 | 6.1 | 9.5 | 9.2 |
| per kg C | kg C | | | | | | | | |
| Gas Traffic | kmol/ | 0.4 | 0.5 | 0.5 | 0.5 | 0.5 | 0.5 | 0.7 | 0.7 |
| | kg C | | | | | | | | |
| Reactor Coke | num | 4 | 4 | 3 | 3 | 3 | 3 | 3 | 3 |
| Level | | | | | | | | | |
| I2 Number | mg/g | | | 55 | 77 | 65 | 79 | 150 | 99 |
| Tint | num | | | | 87 | | 76 | 104 | 95 |
| Toluene | num | | 2 | 75 | 99 | 95 | 97 | 100 | 100 |
| Discoloration | | | | | | | | | |
| 325 Mesh | ppm | | | | 25000 | 28800 | 26100 | | |
| Residue | | | | | | | | | |
| Toluene Extract | % | | 0.9 | | | | | | |

| Example No. | | 49 | 50 | 51 | 52 | 53 | 54 | 55 | 56 |
|---|---|---|---|---|---|---|---|---|---|
| Carrier Gas | name | N2 | N2 | N2 | N2 | N2 | N2 | N2 | N2 |
| Carrier Gas Rate | kmol/h | 2.4 | 2.3 | 2.4 | 2.1 | 2.1 | 1.8 | 1.8 | 1.8 |
| Tracer Gas | name | Ar | Ar | Ar | Ar | Ar | Ar | Ar | Ar |
| Tracer Gas Rate | kmol/h | 0.30 | 0.33 | 0.30 | 0.32 | 0.32 | 0.32 | 0.31 | 0.35 |
| Liquid | kg/h | 4.5 | 2.3 | 6.8 | 2.4 | 4.5 | 2.3 | 4.5 | 6.8 |
| Feedstock Rate | | | | | | | | | |
| Nat. Gas Feed | kmol/h | 0.0 | 0.0 | 0.0 | 0.0 | 0.0 | 0.0 | 0.0 | 0.0 |
| Rate | | | | | | | | | |
| Added Oxygen | kmol/h | 0.0 | 0.0 | 0.0 | 0.0 | 0.0 | 0.0 | 0.0 | 0.0 |
| Rate | | | | | | | | | |
| Reactor | name | 12 | 12 | 12 | 12 | 12 | 12 | 12 | 12 |
| Configuration | | | | | | | | | |
| Throat or | name | Stinger | Stinger | Stinger | Stinger | Stinger | Stinger | Stinger | Stinger |
| Injector Type | | | | | | | | | |
| Used | | | | | | | | | |
| Bifluid Gas | name | Ar | Ar | None | Ar | Ar | Ar | Ar | Ar |
| Bifluid Gas Rate | Nm³/h | 1.6 | 1.6 | 1.6 | 1.6 | 1.6 | 1.6 | 1.6 | 1.6 |
| Gross Torch | kW | 80 | 78 | 78 | 71 | 71 | 65 | 65 | 65 |
| Power Input | | | | | | | | | |
| Net Power After | kW | 25 | 25 | 36 | 30 | 29 | 26 | 26 | 26 |
| Active Heat Loss | | | | | | | | | |
| Reactor O:C | num | 0.0 | 0.0 | 0.0 | 0.0 | 0.0 | 0.0 | 0.0 | 0.0 |
| Reactor H:C | num | 0.9 | 0.9 | 0.9 | 0.9 | 0.9 | 0.9 | 0.9 | 0.9 |
| Meas'd Yield | kg C/ | | | | | | | | |
| | kg FS | | | | | | | | |
| Net Energy Input | kWh/ | 6.7 | 13.4 | 6.3 | 14.9 | 7.6 | 13.4 | 6.7 | 4.6 |
| per kg C | kg C | | | | | | | | |
| Gas Traffic | kmol/ | 0.7 | 1.4 | 0.5 | 1.3 | 0.7 | 1.2 | 0.6 | 0.4 |
| | kg C | | | | | | | | |
| Reactor Coke | num | 3 | 2 | 3 | 2 | 3 | 2 | 3 | 4 |
| Level | | | | | | | | | |
| I2 Number | mg/g | 87 | 113 | 58 | 105 | 77 | 110 | 73 | 40 |
| Tint | num | | 87 | | 79 | 64 | | | |
| Toluene | num | 98 | 98 | 83 | 100 | 100 | 98 | 100 | 33 |
| Discoloration | | | | | | | | | |
| 325 Mesh | ppm | | | | | | | | |
| Residue | | | | | | | | | |
| Toluene Extract | % | | | | | | | | |

| Example No. | | 57 | 58 | 59 | 60 | 61 | 62 | 63 | 64 |
|---|---|---|---|---|---|---|---|---|---|
| Carrier Gas | name | N2 | N2 | H2 | H2 | N2 | N2 | N2 | N2 |
| Carrier Gas Rate | kmol/h | 2.1 | 2.1 | 3.0 | 3.0 | 1.8 | 1.8 | 1.8 | 1.0 |
| Tracer Gas | name | Ar | Ar | Ar | Ar | Ar | Ar | Ar | Ar |
| Tracer Gas Rate | kmol/h | 0.32 | 0.33 | 0.32 | 0.32 | 0.33 | 0.31 | 0.29 | 0.34 |
| Liquid | kg/h | 6.8 | 4.6 | 6.8 | 6.8 | 4.1 | 2.3 | 4.5 | 9.1 |
| Feedstock Rate | | | | | | | | | |
| Nat. Gas Feed | kmol/h | 0.0 | 0.0 | 0.0 | 0.0 | 0.0 | 0.0 | 0.0 | 0.0 |
| Rate | | | | | | | | | |
| Added Oxygen | kmol/h | 0.0 | 0.0 | 0.0 | 0.0 | 0.0 | 0.0 | 0.0 | 0.2 |
| Rate | | | | | | | | | |
| Reactor | name | 12 | 12 | 12 | 12 | 13 | 13 | 13 | 12 |
| Configuration | | | | | | | | | |
| Throat or | name | Stinger | Stinger | Stinger | Stinger | Angled | Angled | Straight | Stinger |
| Injector Type | | | | | | Port | Port | Port | |
| Used | | | | | | Stinger | Stinger | Stinger | |
| Bifluid Gas | name | Ar | Ar | Ar | Ar | Ar | Ar | None | Ar |
| Bifluid Gas Rate | Nm³/h | 1.6 | 1.6 | 1.6 | 1.6 | 1.6 | 1.6 | 0.0 | 1.6 |
| Gross Torch | kW | 71 | 71 | 94 | 117 | 66 | 75 | 66 | 67 |
| Power Input | | | | | | | | | |
| Net Power After | kW | 18 | 29 | 45 | 54 | 30 | 37 | 30 | 6 |
| Active Heat Loss | | | | | | | | | |
| Reactor O:C | num | 0.0 | 0.0 | 0.0 | 0.0 | 0.0 | 0.0 | 0.0 | 0.6 |
| Reactor H:C | num | 0.9 | 0.9 | 12.2 | 12.3 | 0.9 | 0.9 | 0.9 | 0.9 |
| Meas'd Yield | kg C/ | | | | | 0.92 | 0.84 | 0.94 | |
| | kg FS | | | | | | | | |
| Net Energy Input | kWh/ | 3.1 | 7.6 | 7.9 | 9.6 | 8.7 | 19.3 | 7.9 | 1.6 |
| per kg C | kg C | | | | | | | | |
| Gas Traffic | kmol/ | 0.5 | 0.7 | 0.6 | 0.6 | 0.7 | 1.2 | 0.6 | 0.5 |
| | kg C | | | | | | | | |
| Reactor Coke | num | 4 | 3 | 4 | 6 | | | | 0 |
| Level | | | | | | | | | |
| I2 Number | mg/g | 52 | 77 | | 60 | 274 | 251 | 202 | 177 |
| Tint | num | | 63 | | | 101 | | | |
| Toluene | num | 82 | 96 | | 36 | 100 | 100 | 97 | |
| Discoloration | | | | | | | | | |
| 325 Mesh | ppm | | | | | 72800 | 58700 | | 8700 |
| Residue | | | | | | | | | |
| Toluene Extract | % | | | | | | | | |

| Example No. | | 65 | 66 | 67 | 68 | 69 | 70 | 71 |
|---|---|---|---|---|---|---|---|---|
| Carrier Gas | name | N2 | N2 | N2 | N2 | N2 | N2 | N2 |
| Carrier Gas Rate | kmol/h | 1.0 | 1.6 | 1.6 | 1.6 | 1.6 | 1.6 | 1.6 |
| Tracer Gas | name | Ar | Ar | Ar | Ar | Ar | Ar | Ar |
| Tracer Gas Rate | kmol/h | 0.34 | 0.33 | 0.33 | 0.32 | 0.35 | 0.34 | 0.34 |
| Liquid | kg/h | 9.1 | 7.5 | 7.5 | 7.5 | 7.5 | 7.5 | 7.5 |
| Feedstock Rate | | | | | | | | |
| Nat. Gas Feed | kmol/h | 0.0 | 0.0 | 0.0 | 0.0 | 0.0 | 0.0 | 0.0 |
| Rate | | | | | | | | |
| Added Oxygen | kmol/h | 0.4 | 0.2 | 0.1 | 0.1 | 0.2 | 0.2 | 0.3 |
| Rate | | | | | | | | |
| Reactor In Use | name | 12 | 12 | 12 | 12 | 12 | 12 | 12 |
| Throat or | name | Stinger | Stinger | Stinger | Stinger | Stinger | Stinger | Stinger |
| Injector Type | | | | | | | | |
| Used | | | | | | | | |
| Bifluid Gas | name | Ar | Ar | Ar | Ar | Ar | Ar | Ar |
| Bifluid Gas Rate | Nm³/h | 1.6 | 1.6 | 1.6 | 1.6 | 1.6 | 1.6 | 1.6 |
| Gross Torch | kW | 69 | 82 | 82 | 82 | 83 | 86 | 87 |
| Power Input | | | | | | | | |
| Net Power After | kW | 2 | 13 | 13 | 18 | 13 | 13 | 12 |
| Active Heat Loss | | | | | | | | |
| Reactor O:C | num | 1.0 | 0.6 | 0.4 | 0.5 | 0.6 | 0.8 | 1.0 |
| Reactor H:C | num | 0.9 | 0.9 | 0.9 | 0.9 | 0.9 | 0.9 | 0.9 |
| Meas'd Yield | kg C/kg | | | | | | | |
| | FS | | | | | | | |
| Net Energy Input | kWh/kg | 1.6 | 3.6 | 2.7 | 4.4 | 3.7 | 4.9 | 10.4 |
| per kg C | C | | | | | | | |
| Gas Traffic | kmol/kg | 1.5 | 0.7 | 0.5 | 0.6 | 0.7 | 1.0 | 2.4 |
| | C | | | | | | | |
| Reactor Coke | num | 0 | 0 | 2 | 1 | 0 | 0 | 0 |
| Level | | | | | | | | |
| I2 Number | mg/g | 205 | 111 | | 101 | 117 | 135 | 201 |
| Tint | num | | | | | | | |
| Toluene | num | 100 | 99 | | 95 | 100 | 100 | 100 |
| Discoloration | | | | | | | | |
| 325 Mesh | ppm | | 900 | | 2200 | 100 | 200 | 2000 |
| Residue | | | | | | | | |
| Toluene Extract | % | | | | | | | |

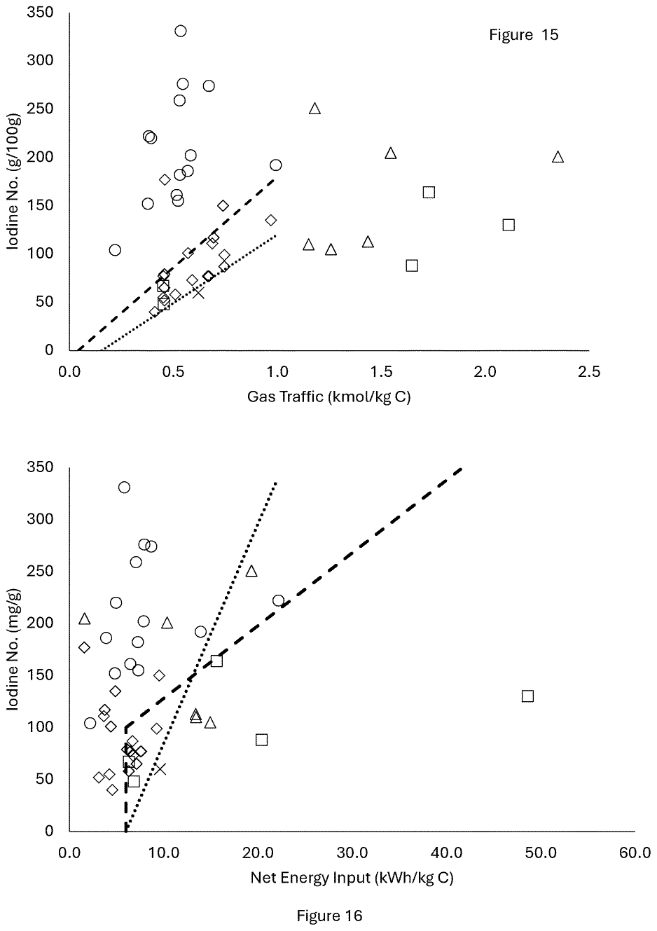

FIGS. 15 and 16 show that the use of a non-hydrogen carrier gas reduced both gas traffic and the net energy required to generate higher surface area carbon black (circle—axial introduction of plasma, nitrogen carrier gas, gas traffic no greater than 1 kmol/kg C; triangle—nitrogen carrier gas, gas traffic greater than 1 kmol/kg C; diamonds—tangential introduction of plasma, nitrogen carrier gas, gas traffic no greater than 1 kmol/kgC; square—axial introduction of plasma, hydrogen carrier gas; x—tangential introduction of plasma, hydrogen carrier gas).

FIG. 15 illustrates the gas traffic for various reaction conditions. For examples employing axial introduction of plasma into the reactor zone; the dashed line separates the examples produced with a nitrogen carrier gas (circles) and having a gas traffic of 1.0 kmol/kg carbon or less from examples produced with hydrogen (squares). All the samples produced with nitrogen have an iodine number of at least 188*gas traffic−8.

Likewise, for tangential introduction of the plasma, the dotted line separates the examples produced with nitrogen carrier gas (diamonds) and having a gas traffic of 1.0 kmol/kg carbon or less from those produced with hydrogen carrier gas (“x”). All the samples produced with nitrogen and having a gas traffic no greater than 1.0 kmol/kg have an iodine number in mg/g of at least 142*gas traffic−22.

FIG. 16 illustrates the net energy used in various reaction conditions. For examples employing axial introduction of plasma into the reactor zone, the dashed line separates the examples produced with a nitrogen carrier gas (circles) and also having a gas traffic of 1.0 kmol/kg carbon or less from examples produced with hydrogen (squares). All the samples produced with nitrogen and having a gas traffic of 1.0 kmol/kg carbon or less have a net energy use (Q) no greater than 6 kWh/kg carbon black for iodine number less than 100 mg/g and I2No≥7Q+58 for iodine number of 100 mg/g or greater.

Likewise, for tangential introduction of the plasma, the dotted line separates the examples produced with nitrogen carrier gas (diamonds) and also having a gas traffic of 1.0 kmol/kg carbon or less from those produced with hydrogen carrier gas (“x”). All the samples produced with nitrogen and also having a gas traffic no greater than 1.0 kmol/kg have an iodine number that satisfies I2No≥21Q−124.

Tangential introduction of the hot carrier gas into the reactor zone provided more stable operation with use of an inert carrier gas (nitrogen). The addition of oxygen to the plasma carbon black reactor (Examples 64-71) dramatically reduced or retarded reactor fouling. In contrast, use of methane as a feedstock (Examples 38-40) reduced yield, increased gas traffic, and increased toluene extractables, even with the use of nitrogen carrier gas.

The foregoing description of preferred embodiments has been presented for the purposes of illustration and description. It is not intended to be exhaustive or to limit the embodiments to the precise form disclosed. Modifications and variations are possible in light of the above teachings, or may be acquired from practice. The embodiments were chosen and described in order to explain their principles and practical application and to enable one skilled in the art to utilize the various embodiments and various modifications as are suited to the particular use contemplated. It is intended that the invention be defined by the claims appended hereto, and their equivalents.

What is claimed is:

1. A method of making carbon black, comprising:
generating a plasma in a gas stream to create a hot carrier gas stream; and
combining a feedstock comprising a liquid feedstock with the hot carrier gas stream to form a mixture, wherein the mixture of the feedstock and the hot carrier gas has an atomic ratio H:C of at most 3:1, to produce a carbon black,
wherein a net energy to manufacture 1 kg of carbon black is no greater than 6 kWh, a gas traffic is no greater than 1 kmol/kg carbon black, or both.

2. (canceled)

3. (canceled)

4. (canceled)

5. (canceled)

6. (canceled)

7. (canceled)

8. (canceled)

9. (canceled)

10. The method of claim 1, wherein the atomic ratio O:C in the mixture of the feedstock and the hot carrier gas is from 0.05 to 2.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A method of making carbon black, comprising:
generating a plasma in a gas stream to create a hot carrier gas stream; and
combining a feedstock with the hot carrier gas stream, wherein the mixture of the feedstock and the hot carrier gas has an atomic ratio O:C of from 0.05 to 2 and an atomic ratio H:C of at most 3:1, to produce carbon black.

26. (canceled)

27. The method of claim 25, further comprising, before combining, introducing the hot carrier gas stream to a reaction zone of a plasma carbon black reactor, the reaction zone having a substantially cylindrical wall, the hot carrier gas stream being introduced at an angle that is within 10 degrees of a tangent to the wall, for example, within 5 degrees, within 2 degrees, or within 1 degree.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A method of making carbon black, comprising:
generating a plasma in a gas stream to create a hot carrier gas stream;
introducing the hot carrier gas stream to a circularly cross-sectioned region of a plasma carbon black reactor, the hot carrier gas stream being introduced along a longitudinal axis of the circularly cross-sectioned region; and
combining a feedstock comprising a liquid feedstock with the hot carrier gas stream to form carbon black, wherein the mixture of the feedstock and the hot carrier gas has an atomic ratio H:C of at most 3:1, wherein a net energy input Q is no greater than 6 kWh/kg carbon black for I2No being less than 100 mg/g and satisfies the equation I2No≥7Q+58 for I2No of 100 mg/g or greater, wherein I2No is in mg/g and Q is in kWh/kg carbon black, and wherein a gas traffic during the reaction is no greater than 1 kmol/kg carbon black.

52. (canceled)

53. (canceled)

54. (canceled)

55. (canceled)

56. (canceled)

57. The method of claim 51, wherein an atomic ratio O:C in the mixture of the feedstock and the hot carrier gas is from 0.05 to 2.

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. A method of making carbon black, comprising:
generating a plasma in a carrier gas stream to create a hot carrier gas stream;
introducing the hot carrier gas stream to a reaction zone of a plasma carbon black reactor, the reaction zone having a substantially cylindrical wall, the hot carrier gas stream being introduced at an angle to the wall that is within 10 degrees of a tangent to the wall; and
combining a feedstock with the hot carrier gas stream to produce carbon black.

73. (canceled)

74. (canceled)

75. (canceled)

76. (canceled)

77. The method of claim 72, wherein a net energy input Q in kWh to manufacture 1 kg of carbon black satisfies I2No≥21Q−124, where iodine number is in mg/g.

78. (canceled)

79. The method of claim 72, wherein the atomic ratio H:C in the mixture of the feedstock and the hot carrier gas stream is no greater than 3:1.

80. The method of claim 72, wherein an atomic O:C ratio of the mixture of feedstock and hot carrier gas ranges from 0.05 to 2.

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. A method of making carbon black, comprising:
generating a plasma in a gas stream to create a hot carrier gas stream;
introducing the hot carrier gas stream to a circularly cross-sectioned region of a plasma carbon black reactor, the hot carrier gas stream being introduced along a longitudinal axis of the circularly cross-sectioned region; and
combining a feedstock comprising a liquid feedstock with the hot carrier gas stream, wherein the mixture of the feedstock and the hot carrier gas has an atomic ratio H:C of at most 3:1, to produce a carbon black,
wherein a surface area of the carbon black satisfies I2No≥188 (gas traffic)−8, where iodine number is in mg/g, gas traffic is in kmol/kg carbon black, and wherein gas traffic is no greater than 1 kmol/kg carbon black.

94. (canceled)

95. (canceled)

96. (canceled)

97. The method of claim 93, wherein a net energy input Q is no greater than 6 kWh/kg carbon black for I2No being less than 100 mg/g and satisfies the equation I2No≥7Q+58 for I2No of 100 mg/g or greater, wherein I2No is in mg/g and Q is in kWh/kg carbon black.

98. (canceled)

99. The method of claim 93, wherein an atomic O:C ratio of the mixture of feedstock and hot carrier gas ranges from 0.05 to 2.

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. A method for producing carbon black, comprising:
generating a first plasma in a first gas stream in a first plasma zone of a plasma carbon black reactor to create a first hot carrier gas stream;
generating a second plasma in a second gas stream in a second plasma zone of the plasma carbon black reactor to create a second hot carrier gas stream;
directing the first and second hot carrier gas streams towards each other along first and second axes such that the first and second hot carrier gas streams combine at a location in a reaction zone having a third axis, wherein the first and second axes are at an angle from 30 to 90 deg to an upstream end of the reaction zone; and
directing a feedstock towards the location, to one more cross-sections of the reaction zone downstream of the location, or both, to mix the feedstock with the combined first and second hot carrier gas streams to produce carbon black, the carbon black leaving the reaction zone at a downstream end.

115. (canceled)

116. (canceled)

117. (canceled)

118. The method of claim 114, wherein the energy input per kg carbon black is no greater than 6 kWh for carbon black having an iodine number less than 100 mg/g and no greater than 9 kWh for carbon black having an iodine number of 100 mg/g or greater.

119. The method of claim 114, wherein an atomic O:C ratio of the mixture of feedstock and hot carrier gas ranges from 0.05 to 2.

120. (canceled)

121. (canceled)

122. (canceled)

123. (canceled)

124. (canceled)

125. (canceled)

126. (canceled)

127. (canceled)

128. (canceled)

129. (canceled)

130. (canceled)

131. (canceled)

132. (canceled)

133. (canceled)

134. (canceled)

135. (canceled)

136. (canceled)

137. (canceled)

138. (canceled)

139. (canceled)

140. (canceled)

141. (canceled)

142. (canceled)

143. (canceled)

144. (canceled)

145. (canceled)

146. (canceled)

147. (canceled)

148. (canceled)

149. (canceled)

150. (canceled)

151. (canceled)

152. (canceled)

153. (canceled)

154. (canceled)

155. (canceled)

156. (canceled)

157. (canceled)

158. (canceled)

159. (canceled)

160. (canceled)

161. (canceled)

162. (canceled)

163. (canceled)

164. (canceled)

165. (canceled)

166. (canceled)

167. (canceled)

168. (canceled)

169. (canceled)

170. (canceled)

171. (canceled)

172. (canceled)

173. (canceled)

174. (canceled)

175. (canceled)

176. (canceled)

177. (canceled)

178. (canceled)

179. (canceled)

180. (canceled)

181. (canceled)

182. (canceled)

183. (canceled)

184. (canceled)

185. (canceled)

186. An apparatus for producing carbon black, comprising:
first and second plasma zones and a reaction zone, the reaction zone having an upstream end and a downstream end;
a first plasma transport zone providing fluidic communication between the first plasma zone and the reaction zone and having an outlet;
a second plasma transport zone providing fluidic communication between the second plasma zone and the reaction zone and having an outlet;
the first and second plasma transport zones each being configured to direct a fluid along first and second axes, respectively, the first and second axes being at an angle of 30-90 deg with respect to the upstream end, the outlets being disposed on a common axis at a perpendicular angle to the reaction zone; and
a plurality of feedstock injectors configured to direct a fluid towards a predetermined location in the reaction zone that is between the two outlets or downstream from the two outlets.

187. (canceled)

188. (canceled)

189. (canceled)

190. (canceled)

191. (canceled)

192. An apparatus for heating a gas with the use of a plasma, comprising:
a tubular inner chamber defined by an inner wall and having an inlet end and an outlet end;
an outer chamber in the form of at least one cylindrical shell between an outer wall and the inner wall, the outer chamber being in fluidic communication with the inner chamber at the inner chamber inlet end;
an electrode disposed at the inner chamber inlet end and oriented along a central axis of the inner chamber; and
an electrode disposed at the outlet end.

193. (canceled)

194. (canceled)

195. (canceled)

196. (canceled)

197. (canceled)

198. (canceled)

199. (canceled)

200. (canceled)

201. A transferred arc plasma apparatus for producing carbon black, comprising:
a plasma zone having an inlet to receive a gas and an outlet in fluidic communication with a reaction zone which the carbon black is produced;
an electrode disposed in the plasma zone; and
an anode bed disposed in the plasma zone and opposed to the electrode, an axis defined by the electrode and the anode bed being perpendicular to a direction of gas flow through the plasma zone;
the anode bed comprising one or more of silicon, iron, aluminosilicates, magnesium oxide, yttria stabilized zirconia, or molten salts.

202. (canceled)

203. (canceled)

204. (canceled)

205. (canceled)

206. (canceled)
